(19) United States
(12) Patent Application Publication
(10) Pub. No.: US 2006/0178905 A1
(43) Pub. Date: Aug. 10, 2006

(54) System and method for managing product sales data for external reports

(76) Inventors: Mona Ayers, Cumming, GA (US); Robert DiChiara, North Haledon, NJ (US)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 11/400,344

(22) Filed: Apr. 7, 2006

Related U.S. Application Data
(63) Continuation of application No. 09/944,803, filed on Aug. 31, 2001.

(51) Int. Cl. G06Q 99/00

(52) U.S. Cl. 705/1

(57) ABSTRACT

A computerized method and system for managing product sales data includes receiving product sales data from one or more external systems and deriving predetermined information from the product sales data. Where the product sales data is replaced or modified, the original product sales data may be maintained. In other embodiments, the system derives average manufacturing prices, non-federal average manufacturing prices and best prices regarding pharmaceutical sales.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates generally to methods and systems for generating and maintaining data and reports generated thereby.

Government agencies often require companies in the healthcare industry to prepare and submit reports detailing pharmaceutical sales. Agency regulations require information in these reports calculated from product sales data typically located in various databases.

### SUMMARY OF THE INVENTION

The present invention recognizes and addresses disadvantages of prior art-arrangements and methods.

Accordingly, it is an object of certain embodiments of the present invention to provide an improved system and method for calculating, generating and maintaining reports for submission to government agencies.

The accompanying drawings, which are incorporated in and constitute a part of the application, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figures, in which:

FIG. 1 is a schematic overview of a system interfacing with data inputs and data outputs according to an embodiment of the present invention;

FIGS. 2-12, 17 and 18 illustrate a user interface for the system according to an embodiment of the present invention;

FIG. 13 is a flow chart showing operation of the system according to an embodiment of the present invention; and

FIGS. 14-16 illustrate an exemplary Non-Federal AMP report that could be submitted to a government agency.

Repeat use of reference characters in the present specification and drawings is intended to represent same or analogous features or elements of the invention.

### DETAILED DESCRIPTION OF PREFERRED EMBODIMENTS

Reference is made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

One or more embodiments of the present invention as described below operates within and/or in conjunction with a distributed computing system. Generally, such a system includes multiple memory storage and computing devices located remotely from each other. The execution of program applications may occur at these remote computing sites as data is transferred among the memory devices and between the computing devices over an extended system. An example of distributed computing systems include the Internet, local and wide area networks, virtual private networks, and point-to-point systems.

Certain operations and processes described herein are executed by one or more computers within a distributed computing system. As should be well understood, a computer transforms information in the form of electrical signals input into the computer to obtain a desired output. The input may be provided by a human operator, another computer, or from other external sources. To accomplish these functions in one computing environment, a conventional general purpose computer includes a processor, read only and random access memory, a bus system and input/output systems to transfer information within the computer and to interact with external devices. The computer's memory includes an operating system and various application programs that run on the operating system.

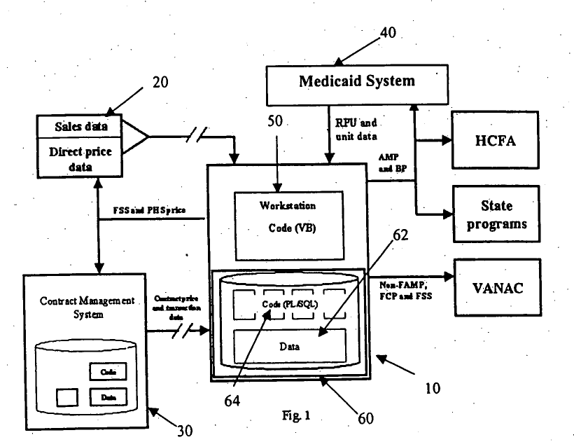

Referring to FIG. 1, an automated processing and reporting system 10 is used for complying with state and federal healthcare regulations. System 10 may be implemented in a client/server environment in which multiple client workstations may be connected through a network to obtain data from a server; alternatively, system 10 may operate on a single, stand-alone computer. System 10 receives product sales data from an order-to-cash system 20 and a contract management system 30 and communicates with one or more other peripheral systems 40. Based upon this input data and calculations performed within the system, the system outputs data to form reports that may be submitted to appropriate government agencies.

A contract management system (“CMS”) is a computer software package that stores and processes data regarding customer contracts. Such contracts may define prices at which a vendor agrees to sell certain specified products to certain customers. CMS information includes, for example, vendor and customer identities, pricing per product, and delivery requirements.

Where the vendor is a product manufacturer that sells primarily to retailers and/or wholesalers, end customers typically buy products directly from these third parties rather than directly from the vendor. Nevertheless, the customer pays under the terms of its contract with the vendor, and the retailer or wholesaler therefore charges the discounts back to the vendor. Customer contracts may also provide for product rebates and feeds this information to system 10, as discussed below. The CMS records charge backs and rebates by product and contract. Contract management systems, for example CARS/IS available from I-many, Inc. of Portland, Me., should be understood in this art. They are not, in and of themselves, part of the present invention, and their operation is discussed herein only as it relates to the present system and method.

An order-to-cash system (“OTC”) is a computer software package housed at a product vendor's facility that maintains and manages product orders through a complete supply line. The OTC receives data input by the vendor that describes multiple orders, tracks the orders through product shipping, and passes financial information resulting from the orders to an accounts receivable system and/or database. OTC information includes, for example, the product(s) sold, actual price, vendor's identity, buyer's identity, order date, delivery date and product quantity. OTC systems, for example PEOPLESOFT's supply chain management applications available from PeopleSoft, Inc. of Pleasonton, Calif., should be understood in this art. OTC systems are not, in and of themselves, part of the present invention, and their operation is discussed herein only as it relates to the present system and method.

Reference data may include standards and classifications relating to trade in the industry relevant to contracts and orders maintained by the CMS and the OTC. In one embodiment, the present system assimilates and reports pharmaceutical sales data, and reference data therefore includes classifications and information relating to pharmaceuticals. For example, the Food and Drug Administration (“FDA”) has established codes. (“NDC codes”) that correspond to particular pharmaceutical products. In the present embodiments described herein, user-defined “trade classes” identify entities (such as wholesalers, hospitals, nursing homes, veterinarians, etc.) that participate in sales transactions. In these present embodiments, reference data includes the NDC codes and a list of those trade classes within which fall purchasers of pharmaceutical products. Reference data also includes parameters, such as the consumer price index (“CPI”), needed by pharmaceutical companies to calculate report data required by agency regulations. Reference data resides at system 10, as discussed in more detail below.

System 10 may communicate with other peripheral systems with which it exchanges information. A pharmaceutical company may use a Medicaid payment system 40 (such as CARS/MEDICAID, available from I-many of Portland, Me.), for example, to assist in making Medicaid payments to states. Medicaid payment system 40 downloads information from system 10 relating to product pricing (e.g. average manufacturing price and best price), which it needs for Medicaid processing, and outputs to system 10 a rebate amount per product unit (RPU), which system 10 needs for its information processing related to the Health Care Finance Administration (HCFA). (HCFA has recently been renamed the Centers for Medicare and Medicaid Services, or CMS. To avoid confusion with that acronym as used herein with respect to the contract management system, however, HCFA will be used.) Medicaid payment system 40 is provided for illustrative purposes only, and it should be understood that system 10 may be used in conjunction with a variety of peripheral systems.

System 10 includes software modules, for example written in VISUAL BASIC or other suitable language, that extract predetermined product sales data from the OTC, the CMS or other peripheral systems and store the extracted information in a system database. The term “product sales data” as used herein refers to any data extracted from a peripheral system that describes products sales and/or pricing, including charge backs and rebates related to customer or government contracts. These modules may vary depending on the particular data needed for a given report and the particular system from which data is extracted. Those skilled in the art, however, should be familiar with the extraction of data into databases through computer programming and the population of output tables with data stored in a database. Thus, specific extraction and population modules are not discussed in detail herein.

System 10 includes at least one client workstation 50. Client workstation 50 has application software loaded thereon that allows a user to perform calculations and to create reports populated by the results of those calculations. The application software automatically archives each calculation, including both the calculation result and its input data.

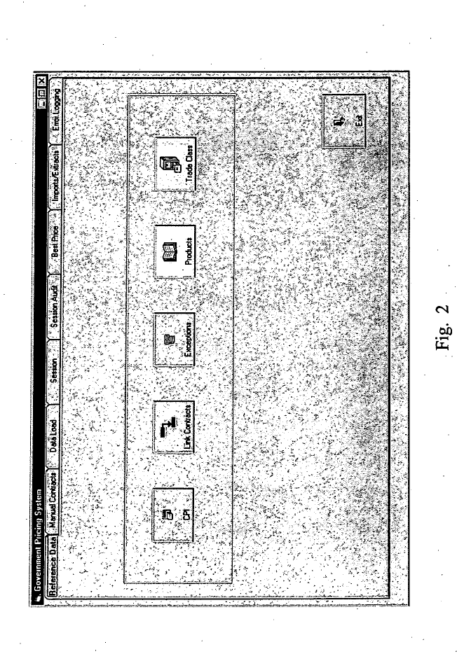

A user controls the application through a user interface included with the application software. The user interface, described below with respect to FIGS. 2-12, is preferably written in a programming language such as VISUAL BASIC; however, it should be understood that other programming languages could be used.

A server 60 communicates with local workstation 50 over a network (not shown). A database 62 resides on server 60 and receives the product sales data and reference data from the extraction modules stored at the server. Procedures 64, also stored at the server, load requested information from database 62 to the user interface and to reports. The local workstation preferably interfaces with the database using Open Database Connectivity (“QDBC”). ODBC is middle-ware in the sense that the application software on the local workstation issues instructions to the ODBC layer to obtain information from the database. Since ODBC uses uniform programming instructions, regardless of the database that houses the data, the application software need not take into account any proprietary instructions usually necessary when connecting directly to a database. Accordingly, BDBC may avoid any proprietary instructions necessary for connecting to the database. It should be understood, however, that other database interfaces, such as JDBC, could be substituted.

Stored procedures 64 are preferably written in PL/SQL (Procedural Language Extension to SQL), a programming language available on ORACLE™ servers. SQL, which stands for “Structured Query Language,” is a standard query language designed to query relational databases. PL/SQL, as implemented in ORACLE™ databases, is a procedural language geared towards implementing rules and other business logic in the database server. Once deployed, the stored procedures reside in and are executed from the database server. It should be understood that other suitable programming languages could be substituted for PL/SQL.

The driving force behind government reporting is the need for regulatory compliance and to provide statistics and validation regarding transactions. Pharmaceutical companies that hold Medicaid agreements, for example, are required to report “average manufacturing price” (AMP) and “best price” (BP). VA contracts require, “non-federal average manufacturing price”. (NFAMP), NFAMP annual, “federal ceiling price” (FCP), “federal supply schedule price” (FSS) and “industrial funding fee” (IFF). Office of Pharmacy Affairs programs result in a “public health service” (PHS) prices for certain customers. Agency regulations define each statistic. Each of these calculations, which are described in detail below, relies on product sales data extracted from peripheral sources such as the OTC and CMS and stored in database 62 in Tables A1 through A5.

Table A1 lists the data fields for each data record describing each product sale. “SetId” identifies the peripheral system (the OTC in the case of Table A1) from which sales data is extracted. The year and quarter identify the time during which the sale occurs, although it should be understood that any suitable date definition may be used. The product and purchaser are identified by NDC code and trade class, respectively, rather than by name. Gross quantity refers to the number of units of the product sold, and gross sales is the amount at which that quantity was sold (i.e. gross quantity multiplied by the actual sales price). If there are any billing errors in the sale, such that the sales price is thereafter adjusted, the data record includes an adjustment amount and an adjustment quantity—i.e. the value and number of product units to which the error applies. The return quantity and the return amount are the number of product units, and the value of those units, returned to the vendor after the sale.

The “Load” date is the date on which the sales data is downloaded from the peripheral system. “Thru date” is the last date on which the sales data is valid. Thru date defaults to Dec. 31, 2100. If the data record is changed, the system automatically changes Thru date to the current date, i.e. the date the record is changed, and does not delete the record. For example, as discussed below, each sales data extract in the present embodiments describes sales over a certain calendar year and quarter. All the records in Table A1 in a given extract for a given year/quarter have a Thru date of Dec. 31, 2100 at the time the extract occurs. If an operator then executes another extract for the same year/quarter, the system changes the Thru dates for all records in the first extract to the present date. The present date is also the Load dates for the second extract, which now has Thru dates of Dec. 31, 2100. As discussed in more detail below, this preserves the data records for possible later audit. “Load date” and “Thru date” are used consistently in this manner throughout the product sales data tables described herein.

As noted above, product sales should be offset by rebates and charge backs resulting from customer contracts. Since these events relate to contracts rather than individual sales, the system does not link rebates and charge backs to particular sales in Table A1. For example, a vendor might make three separate sales of 100 cases of a certain drug to a pharmaceutical wholesaler. Some time later, a retailer may purchase 50 cases from the wholesaler. If the retailer has a contract with the vendor that entitles the retailer to a discount, the retailer buys the 50 cases from the wholesaler at the discounted price, and the wholesaler charges the discount back to the vendor. The wholesaler typically cannot, however, identify the particular one of the three sales in which it might have purchased the cases.

Table A2 lists the data fields for each data record describing a charge back and/or rebate. Again, “SetId” identifies the peripheral system (in this case the CMS) from which the system extracts the data, and year and calendar quarter establish the time at which the event occurs. The event may be entirely a rebate, entirely a charge back or a combination of the two. Thus, the record includes data fields for the number of product units rebated, the rebate amount, the number of product units charged back and the charge back amount. “Contract Sales List” (also extracted from the CMS) is the value of the rebated and/or charged back units at list price. That is, it is equal to the sum of charged back units and rebated units (i.e. “Contract Units”), multiplied by the product list price.

While contract sales data in Table A2 is typically downloaded from the CMS, it is also possible for a user to manually enter these records, as described in more detail below. If this occurs, the “Manual Flag” is set to “Y.”

Table A3 provides pricing data by trade class, product code, year and calendar quarter. The system recognizes six types of prices: list price, rebate price offered, rebate price taken, charge back price, direct sales price and best price. The first five are “price types” that are identified in the corresponding field in Table A3. That is, all price records in Table A3 are identified as one of these five price types. Certain of these prices may also, however, be identified as best prices in procedures described below. A given product may have any or all five prices in any calendar quarter for multiple trade classes. The price type field identifies which price type applies to the data record's price field, and “SetId” identifies the peripheral system from which the price is extracted.

The list price is the book price (for the specified NDC during the specified year and quarter), i.e. the price before any contract rebate or discount. Thus, where the price is a list price, the three contract fields are blank. In the present embodiment, list price comes from the OTC.

Rebate price and charge back price come from the CMS. Because there may be several contracts applicable to a given trade class under which rebates and charge backs occur in a given quarter, the system identifies the contract name and start and end dates for each rebate and charge back price. The rebate price is list price reduced by a rebate amount and is identified as either an “offered” or “taken” price. A vendor might offer several rebates over any given period, but customers might not take advantage of all rebates. The system's CMS extraction module looks in the CMS for the best rebate price offered by the vendor for each NDC to each..trade class for each calendar quarter in the extract period and creates a corresponding record in Table A3 for each price. The CMS also tracks the best rebate price taken by customers, and the extraction module creates corresponding records for each of these prices as well.

The charge back price is list price reduced by a charge back amount. The extraction module looks in the CMS for the best charge back price for each NDC to each trade class for the calendar quarter in the extract period and creates a corresponding record in Table A3.

Direct sales price is the best price at which a product is sold to customers not subject to a contract price. For a given product (defined by an eleven-digit NDC code), the extraction module looks for the product's lowest price not associated with a contract and creates a corresponding record in Table A3.

The extraction module also extracts into Table A3 the package size, in number of milliliters, in which the product identified in the record is sold. The system divides the record's price by the package size to populate a price per milliliter field (ML Price). It should be understood that package size isn't necessarily defined in milliliters. Thus, while “ML” is a convenient field description, data in the ML price field is not necessarily in terms of price per milliliter.

In a best price worksheet procedure described below, the system selects a best ML Price for each product in a given quarter from among the prices in Table A3 that are subject to the best price procedure.(described below), over all contracts and trade classes. The user has the ability to approve the selected price as the best price through activation of an approval flag. If a particular price is approved to be the best price, this is so indicated in the approval flag field for the corresponding record in Table A3.

As discussed above, rebates and charge backs may occur pursuant to customer contracts. Rebates may also occur, however, pursuant to government programs such as Medicaid. For example, a party covered by Medicaid may purchase a drug at a reduced price pursuant to Medicaid regulations. The retailer receives a rebate from the state, which then receives rebates from pharmaceutical vendors. The pharmaceutical vendor submits average manufacturing price and best price data (described below) to its Medicaid system 40 (FIG. 1), which then determines the vendor's rebate per unit (RPU) that in turn determines the vendor's rebate to the state. The vendor also reports the relevant pricing data to HCFA.

The system outputs to Medicaid payment system 40 the average manufacturing price and best price for each product in a given calendar quarter and over all trade classes. The Medicaid payment system responds with product RPU's, which the system stores in Table A4. “SetId” again identifies the peripheral system (in this case CARS/MEDICAID) from which the data is extracted. The program type is a description of the applicable government program, in this case Medicaid.

Table A5 describes the price types used in Table A3. That is, each of the five price types has a corresponding record in Table A5. The price type field in Table A3 links the price description field in Table A5 to certain screen displays in the system's user interface described below. The price order field defines the order in which the prices are displayed.

Tables B1 through B5 store reference data. Table B1 includes a record for each product (by its NDC number) that sets parameters governing how the system's statistical an lysis addresses product data. Specifically, in these examples, each record lists the product's calculation indicator, drug category, Medicaid applicability period and Veteran's Administration applicability period. The data is defined by the system user through hard coding or, as discussed below, a user interface.

The available calculation indicators in these examples are “s” (single source), “i” (innovator) or “n” (non-innovator) The Social Security Act defines these indicators, and product manufacturers classify their products with the appropriate indicators based on the Act's definitions. Calculation indicators determine, at least in part, which prices are considered in the best price worksheet and, therefore, in the best price session (described below). In these embodiments, only prices having “s” and “i” indicators are considered.

Drug category identification defines to which of two general calculation groups the product pricing information will apply. Each calculation group corresponds to one or more particular reports that require the results of calculations in that group. For example, the presently described embodiments generate reports in accordance with Medicaid and VA regulations, and there are, therefore, respective calculation groups that determine statistics for Medicaid and VA reporting. Medicaid calculations include AMP, best price and AMP9. VA calculations include NonFAMP, FSS, IFF and FCP. These calculations are described in more detail below.

In the embodiments described herein, there are four possible values for drug category: X, B, V and M. “X” indicates that pricing data for the drug identified by the NDC Code field is not to be used in any calculations. This may occur, for example, where the vendor manufactures and sells pharmaceuticals not applicable to Medicaid or VA programs. “B” indicates that a drug's pricing data is to be used in both Medicaid and VA calculations, whereas “V” indicates the data is used only for VA calculations. “M” indicates the data is applicable to Medicaid calculations only. Even if a drug's category is B, V or M, the drug might be subject to HCFA and/or VA regulations at some time. Thus, the user may enter an HCFA Medicaid Expiry Date and/or VA Disconnect Date, after which the drug's pricing data is excluded from the applicable calculations. Typically, the exclusion dates correspond to the manufacturer's discontinuance of the product.

Table B1 also defines the units of measure and package size for each product. This information is presented in a pricing table described below with respect to the system's user interface.

Table B1, as do other reference data tables, includes a “From Date” and a “Thru Date.” The Thru date operates as discussed above with respect to the product sales data tables. It defaults to Dec. 31, 2100 but changes to the current date if the user overrides a data record, thereby preserving the record for auditing purposes. The From date is the date on which the user enters the data record.

Table B2 stores trade class parameters set by the user. Each trade class includes an identification string and description. Each is defined as a “federal,” “retail” or “wholesaler” trade class, depending upon its characteristics, by a “Y” in the appropriate data field in Table B2. Only one of the three fields can be activated at any given time. As described in more detail below, the various calculations discriminate among sales data depending on the whether the applicable trade class is federal, retail or wholesale.

Certain calculations (in this.embodiment, average manufacturing price and other AMP type calculations) apply directly to sales and include algorithms that select sales data records from Tables A1 and A2 according to three criteria specific to each calculation. Each calculation applies to one or more drug categories, and the algorithm therefore first selects those sales data records in Tables A1 and A2 having the appropriate drug categories in Table B1. Second, the algorithm checks Table B1 for each selected NDC code to confirm that the present date is prior to the HCFA or VA (as appropriate) expiration date, eliminating those sales data records corresponding to expired NDC codes. A calculation may also be restricted to one or more trade class types, and, in the third step, the algorithm selects those remaining sales data records having NDC codes with the appropriate trade class flags in Table B2. The algorithm then applies its calculation rules to the data in the surviving sales data records.

The user may define exceptions to the trade class (third) criteria through Table B4. The table includes fields for NDC code, calculation identification and trade class. If the user enters data for these fields, the specified calculation algorithm ignores the trade class criteria for the specified NDC code and selects sales data records for the NDC code only for the specified trade class. For example, suppose a calculation is restricted to M-type products sold to federal trade classes. Suppose also that there is a data record in Table B4 for one of these M-type products that specifies the calculation and a non-federal trade class. The calculation then considers sales data records for this product only for sales to this trade class, whether or not the trade class meets the calculation's criteria. The user may enter multiple trade class exceptions for a given NDC code for a given calculation.

The trade class exception is useful where a government regulation requires that a statistic be based on sales to a certain trade class type but where the government allows consideration of sales to other trade classes for certain products having relatively low sales to the designated class type. Furthermore, only the NonFAMP calculation references the exceptions table in the present embodiments. In other embodiments, however, exceptions could also be appropriate to the calculation identification and drug category criteria, or other criteria, and the present invention encompasses other suitable exceptions.

Other calculations, principally Federal Ceiling Price, apply to pricing records in Table A3 for contracts linked to the calculations in Table B5 (in the case of Federal Ceiling Price, the link is to FSS, as described below). That is, for each contract to which a calculation applies, the user enters the calculation's identification number and the contract's identification number in the appropriate fields in Table B5. Upon execution, the calculation algorithm finds each record in Table B5 having the calculation's number, identifies the contract numbers in those records, selects the pricing data records in Table A3 having those contract numbers, and applies its calculation rules to the data in the selected records.

The best price algorithm also applies to contract price information, but unlike Federal Ceiling Price, it applies by default to all contract pricing data in Table A3. Thus, links between the best price algorithm and contracts in Table B5 define exceptions to the default rule. That is, if the user links a contract to the best price calculation in Table B5, the calculation ignores pricing data records in Table A3 for that contract. As discussed above, the best price calculation also excludes price records based on product calculation indicators in Table B1.

It should be understood that various statistical requirements may be defined in various suitable manners and that the present system may determine and report different statistics and other data required by agency regulations. For example, “best price” is, generally, the lowest price charged by the vendor for a given product. In the present example, best price applies only to Medicaid calculations and, therefore, only to price data for those products having a “B” or “M” calculation indicator in Table B1. It is the lowest price at which a manufacturer sells such a drug to a U.S. purchaser under any pricing structure. It includes prices to wholesalers, retailers and nonprofits, but it excludes federal supply schedule prices (i.e. prices at which products are sold to federal agencies and others, as permitted by the General Service Administration, under the Federal Supply Schedule), nominal prices, prices available to the federal government through the depot procurement system and prices to the federal government under any contract establishing a single supplier for a covered drug. The best price algorithm is described below with respect to the user interface.

Generally, AMP is the net quarterly sales divided by the number of units sold. In the presently described embodiment, it is the average unit price in a given calendar quarter paid to the manufacturer (referred to as the “labeler” in HCFA regulations) for a given pharmaceutical product. The AMP calculation applies to products that are subject to Medicaid rebates, i.e. to products in Table B1 having a Medicaid expiration date that is blank or greater than the present date and having a calculation indicator of “B” or “M.” It applies to products that are distributed by wholesalers to retail pharmacies. That is, for example, AMP excludes direct drug sales to hospitals and HMOs and may also exclude, where present, sales of products that wholesalers relabel under their own NDC's and distribution of free goods. The latter two instances may be addressed through the addition of appropriate trade class flags in Table B2 that would thereby identify wholesaler-relabeler sales, and free sales, in Table A1 and through definition of exceptions in the AMP algorithm, possibly including the exceptions table in Table B4.

The AMP algorithm selects those data records in Tables A1 and A2 that describe sales of Medicaid-covered products during the calendar quarter selected by the user in the user interface to retail trade classes, as defined in Table B2, and respectively sums Gross Sales, Gross Quantity, Return Quantity, Return Amount, Adjustment Amount, Adjustment Quantity, Rebate Amount and Charge Back Amount. For the same products, the algorithm selects those data records in Table A2that have non-retail trade classes and respectively sums the Contract Sales List values and Contract Units values over those records. The algorithm then proceeds as follows:

Gross Retail Sales=(summed (retail) Gross Sales−summed (non-retail) Contract Sales List) * 0.98

Net Retail Sales=Gross Retail Sales−summed (retail) Return Amount−summed (retail) Adjustment Amount−summed (retail) Charge Back Amount−summed (retail) Rebate Amount

Net Retail Quantity=summed (retail) Gross Quantity−summed (retail) Return Quantity−summed (retail) Adjustment Quantity summed (non-retail) Contract Units

AMP=(Net Retail Sales)/(Net Retail Quantity)

AMP(ML)=(AMP)/Package size)

The system subtracts non-retail contract sales from retail gross sales to provide an assessment of downstream sales to non-retail customers. That is, the pharmaceutical manufacturer may sell products to a retail customer, who may then sell to a non-retail party having a contract with the manufacturer. In that case, the non-retail customer (e.g. a hospital) receives a discount or rebate, which is then applied back to the manufacturer and recorded in Table A2 as a charge back or rebate and is therefore included in Contract Sales-List. Since these sales were recorded in Table A1 as retail sales, but where non-retail in the end, the AMP algorithm removes them from the gross sales number. Following these steps, the algorithm subtracts retail returns, adjustments, charge backs-and rebates. Gross sales is multiplied by 0.98 to account for a 2% discount for meeting payment terms.

As with gross sales, the algorithm subtracts non-retail contract units from gross quantity. Retail returns and adjustments are subtracted to provide net retail quantity. Net retail sales is divided by net retail quantity to determine AMP, which is divided by the product's package size to assess AMP per package size unit.

The AMP algorithm produces an AMP for each product identified by an eleven-digit NDC. As should be understood, the first five digits in an NDC identify the manufacturer's labeler code. The next four digits identify the product itself, whereas the last two digits specify the package size for that product. For example, the NDC 58768010005 refers to the product VOLTAREN (0100) in 5 ml size (05) from Novartis Opthalmics (58768). Thus, where a product is sold in multiple package sizes, each product/size arrangement has its own NDC and is considered a separate product by the database and the AMP calculation in the presently described embodiments.

The AMP9 algorithm determines an average manufacturing price for the product regardless of package size. Generally, the algorithm applies a weighted average to the AMP values determined for eleven-digit NDCs having common nine-digit stems. For a given calendar quarter and for each nine-digit product family, the algorithm retrieves the AMP calculation values associated with all eleven-digit NDCs having the nine-digit stem, sums Net Retail Units (multiplied by package size) and Net Retail Sales, and divides summed Sales by summed Units. The system stores the result as the AMP9 value for all the eleven-digit NDCs.

Generally, the non-federal average manufacturing price (Non-FAMP). is the net sales of wholesalers to non-federal customers, divided by the number of product units in those sales. The Non-FAMP calculation applies to products in Table B1 having a VA expiration date that is blank or greater than the present date and having a calculation indicator of B or V. The algorithm selects those data records in Tables A1 and A2 that. describe sales of these products to wholesaler trade classes, as defined in Table B2. Unlike the AMP calculation, Non-FAMP may be applied over a single quarter or over a calendar year, depending on the calculation sequence chosen by the user. The quarterly Non-FAMP algorithm selects sales data records for sales during the calendar quarter selected by the user. The annual NonFAMP algorithm selects records for sales during the first three quarters of the current year and the last quarter of the prior year. From these records, the algorithm selects those not linked to exceptions in Table B4 and respectively sums Gross Sales, Gross Quantity, Adjustment Amount and Adjustment Quantity for those records. For those records having NDC codes linked to trade classes in Table B4, the algorithm selects all sales data records in Tables A1 and A2 describing sales during the relevant time period to the specified trade classes and respectively sums Gross Sales, Gross Quantity, Adjustment Amount and Adjustment Quantity. Regardless of the exceptions in Table B4, these are all considered to be “Wholesaler” values in the algorithm.

For the same products, the algorithm selects those data records in Table A2 that have federal trade classes and respectively sums the Contract Sales List values and Contract Units values over the relevant time period.

Also for the same products, the algorithm selects those data records in Table A2 that have non-federal trade classes and sums Charge Back Amount over the relevant time period. The algorithm then proceeds as follows:

Gross Non-Federal Sales=(summed (wholesaler) Gross Sales−summed (federal) Contract Sales List) * 0.98

Net Non-Federal Sales=Gross Non-Federal Sales summed (non-federal) Adjustment Amount−summed (non-federal) Charge Back Amount

Net Non-Federal Quantity=summed (wholesaler) Gross Quantity−summed (non-federal) Adjustment Quantity−summed (federal) Contract Units

NonFAMP=(Net Non-Federal Sales)/(Net Non-Federal Quantity)

Since wholesalers to whom the pharmaceutical manufacturer has sold products, as recorded in Table A1, may then sell some of these products to federal or non-federal customers without the manufacturer's knowledge, and since such secondary sales generally result in charge backs and rebate records in Table A2, the contract sales records in Table A2 can be used to assess sales from wholesalers to their federal customers, and those records' Contract Sales List values therefore reflect the value of those sales at list price. Accordingly, the algorithm subtracts summed federal Contract Sales List from summed wholesaler gross sales to assess gross sales by the manufacturer to wholesalers that ultimately became sales to non-federal end customers. Again, this number is multiplied by 0.98 to account for payment term discounts. Non-federal adjustment amount and charge back amount are subtracted to assess net non-federal sales.

Federal Ceiling Price (FCP) is a price charged under federal agreement and is statutorily limited not to exceed 76% of Non-FAMP over a corresponding period. The FCP calculation requires that the system has run annual Non-FAMP for the current year (ANF), quarterly Non-FAMP for third quarter of the prior calendar year (PNF3) and quarterly Non-FAMP for third quarter of the current calendar year (CNF3). Initially, the FCP algorithm checks Table B5, identifies those contracts linked to the FSS calculation, and selects the pricing data records from Table A3 for those contracts for third quarter of the present calendar year. As noted above, the FSS price is a price at which products are sold to federal agencies, as permitted by the General Services Administration, under the Federal Supply Schedule. If there are multiple sets of price records for FSS contracts for the relevant NDC code in the relevant quarter, the algorithm selects the set having the latest load date, provided of course that the load date is on or before the present date and that the present date is on or before the Thru date.

The algorithm then proceeds as follows:

Max FSS=(Selected FSS Price for the quarter) * (1+CPI)

If PNF3 and CNF3 are both greater than zero, Additional Discount=(CNF3−PNF3)−(PNF3) * CPI Else, Additional Discount=zero

Calculated Ceiling=(ANF * 0.76)−Additional Discount, if result is greater than or equal to zero

If result is less than zero, Calculated Ceiling=0.01

If present year is first calculation year, FCP=Calculated Ceiling

If present year is not first calculation year, FCP=lesser of Calculated Ceiling and Max FSS, provided that Max FSS is greater than or equal to 0.01

If ANF is less than or equal to zero, set FCP to Max FSS.

The FSS calculation simply sets FSS equal to the FCP for the selected year and quarter. As indicated in FIG. 1, FSS Price is output to the order-to-cash and contract management systems for use in transaction management. FSS with IFF is equal to FSS * 1.005. IFF (Industrial Funding Fee) is a 0.5% administrative fee added to negotiated prices of FSS-eligible entities, except the Department of Defense.

A Public Health Service (PHS) price is used in determining charge backs for customers subject to the Section 340B Drug Discount Program administered by the Office of Pharmacy Affairs. The algorithm retrieves, for each NDC, the AMP9 calculation and RPU for the quarter two quarters prior to the present quarter, subtracts RPU from AMP9, and multiplies the result by the NDC's package size. PHS prices are provided to the CMS (FIG. 1) and to wholesalers and PHS end customers to facilitate their transactions.

Upon launching the application software residing on the local workstation, the user is presented with a user interface shown in FIG. 2. The window contains multiple tabs allowing the user to perform various functions: Reference Data, Manual Contracts, Data Load, Session, Session Audit, Best Price, Import/Export and Error Logging. In order to exit from the application, the user selects the “Exit” button.

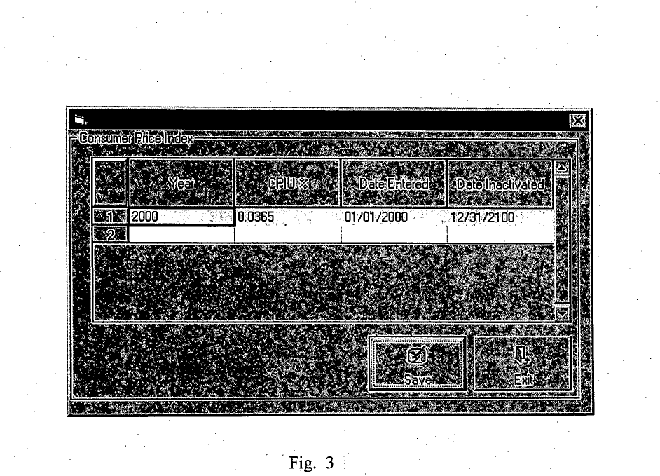

With the “Reference Data” tab selected, the user may review and maintain reference data, including CPI, Link. Contracts,. Exceptions, Products, and Trade Classes. As indicated above, the system uses CPI in several calculations needed to comply with pharmaceutical-related reports. By selecting the “CPI” button shown in FIG. 2, the user may review archived consumer price index information and modify the current consumer price index through a window (shown in FIG. 3) that contains a table populated with data from one or more entries in Table B3. The table describes present and past CPI's and the time periods for which each was applicable.. For example, the table shown in FIG. 3 displays a 0.0365 CPI percentage in the year 2000 that is active until Dec. 31, 2100. Any calculations executed during this period use this CPI. Thus, a user auditing data reported at some time in the past may refer to this table to determine what CPI was used to derive data in a given report. To enter a new CPI, the user enters the CPI and its pendency date within row “2” and selects the “Save” button. The new CPI will be added to Table B3. and thereafter used in system calculations. The “Thru” date in Table B3 for the record corresponding to row “7” changes to the present date, and the data record remains in the database for auditing purposes. If the user does not want to save changes that have been entered within the window, the “Exit” button returns the user to the window displayed in FIG. 2.

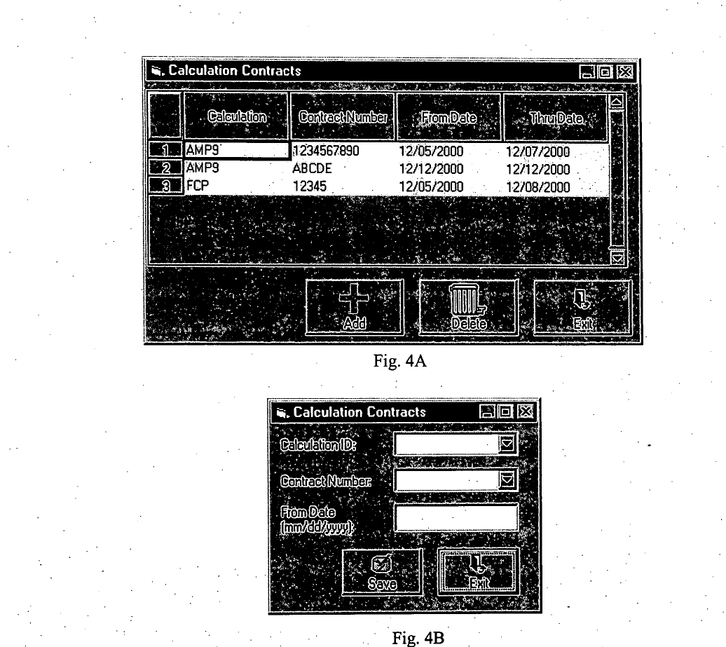

FIG. 4A illustrates a window displayed upon selecting the “Link Contracts” button (FIG. 2) that displays the contract/calculation links described above with respect to Table B5. For example, contract 12345 is linked to the FCP calculations for contract data between Dec. 5 and Dec. 8, 2000. As noted above, if a contract is linked to the BP calculation, BP ignores the specified contract. The table in FIG. 4A is provided for illustration only. For example, the AMP9 and FCP calculations in the present embodiment do not link to contracts in Table B5.

To create a link between a calculation and a contract, the user clicks on the “Add” button illustrated in FIG. 4A, thereby loading a window illustrated in FIG. 4B. This window has pop-up lists with which the user selects the desired calculation and contract. The calculation identifications displayed in the pop-up list are obtained from database Table D8. Contract numbers are obtained from Table A3.

The user establishes the date from which the link between the calculation and contract will start by typing in a date in the “From Date” text field. The link is added to database Table B5 by clicking the “Save” button; otherwise, the user may click on the “Exit” button to return to the screen illustrated in FIG. 4A.

To delete a link between a calculation and a contract, the user may click on the “Delete” button for any given link in the FIG. 4A window. Upon deletion, the application changes the “Thru Date” in FIG. 4A to the current date, rather than actually deleting the entry. This records the link's deletion date. Thus, the links, and the periods over which they are applicable, remain in the database and may be reviewed in an audit at a later time.

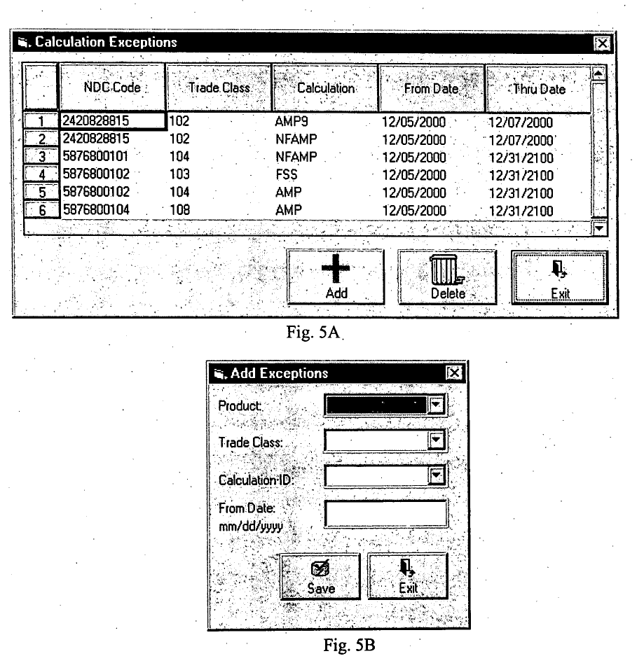

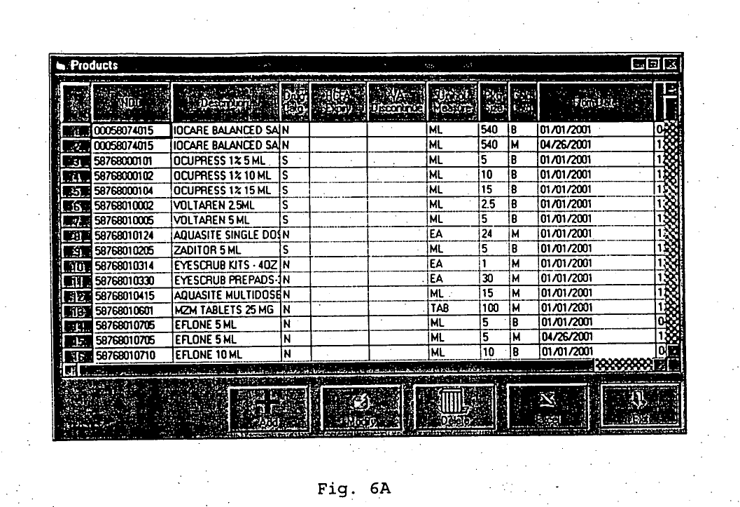

If the user selects the “Exceptions” button shown in FIG. 2, the application displays a window shown in FIG. 5A, the data from which is retrieved from Table B4. Through this interface, as described above, the user may link products to trade classes so that the specified algorithm applies to sales and/or pricing data records for the product only for the specified trade classes, regardless of algorithm rules that would otherwise select different trade classes. FIG. 5A is provided for purposes of illustration only. In the present embodiments, these type of exceptions apply only to the Non-FAMP calculations, although it should be understood that Table B4 could be used to define exceptions to other algorithm rules, depending on the algorithm.

To add an additional exception., the user clicks on the “Add” button to bring up a window shown in FIG. 5B. This window allows the user to choose a particular product, trade class and calculation ID from data stored in the database and to select a time period during which the exception will occur. When the user activates the “Save” button, the application adds the information to the database in Table B4; otherwise, the user may simply select the “Exit” button to return to the window shown in FIG. 5A. To delete an exception, the user chooses a particular product and selects the “Delete” button. To facilitate auditing, the application changes the “Thru Date” in the database to the current date, as opposed to deleting the entry.

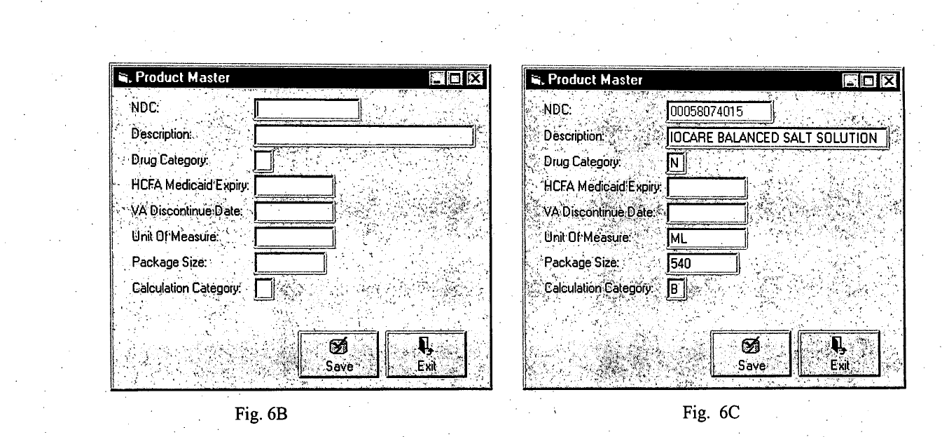

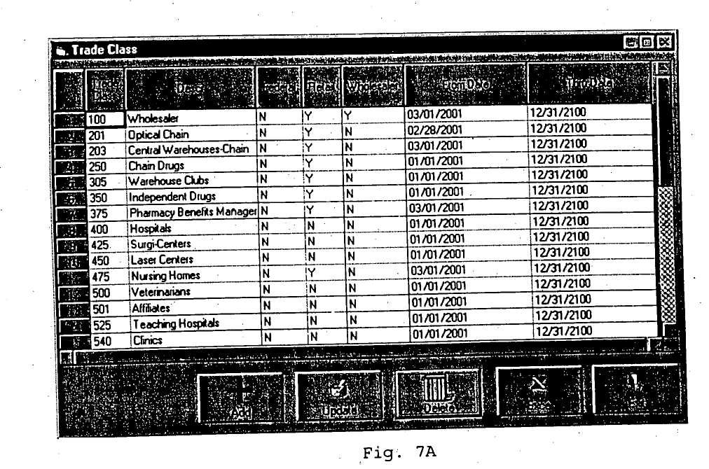

if the user activates the “Products” button shown in FIG. 2, the application displays the window illustrated in FIG. 6A. This interface allows the user to maintain and modify the master product list of Table B1. As described above, this user-defined data describes products the system expects to see when the system extracts data from peripheral systems. If an extract downloads data for an NDC code not present in Table B1, the system so notifies the user by presenting the “Products” button in a color different from that of the other buttons or by providing some other suitable indicator. Once the user reviews that product data, as described in more detail below, the button or other indicator changes to its default state.

Data from Table B1 populate the columns illustrated in FIG. 6A: “NDC,” “Description,” “Drug Category,” “HCFA expiry,” “VA Discontinue,” “Unit of Measure,” “Package Size,” “Calculation Category,” “From Date” and “Thru Date”. The NDC column provides the national drug code number for a particular product. The drug category column may be one of “s” (single source), “n” (non-innovator), or “i” (innovator), depending upon the particular drug. The HCFA expiry date is the actual date (quarter) that Medicaid pricing data is no longer required, which is four quarters beyond the product's termination date. The VA discontinue date is the actual date that VA calculations should no longer be performed for that particular product, due to product deletion or discontinuation from the VA contract. The unit of measure illustrates the type of metric that is used for measuring the product, and the package size column shows the: quantity in which the products are distributed.

The calculation category column may be “X”, “B”, “M”, or “V”, depending upon the calculations in which the product will be used. As described above, “X” corresponds to products upon which no calculations are applied; “B” indicates that both VA and Medicaid calculations apply; “V” stands for VA calculations and “M” may be used to associate Medicaid calculations. In short, however, each category corresponds to a group of predefined calculations.

If a user selects the “Add” button, the application displays a window shown in FIG. 6B. The user may enter the data requested in the screen and click the “Save” button to add a product to Table B1; otherwise, the user may click the “Exit” button. In order to modify existing product information, the user may select the “Modify” button in FIG. 6A, thereby loading the window shown in FIG. 6C. The system populates data fields in FIG. 6B window with information currently defined in the database for the selected product. The NDC text field, which identifies the selected product, is unalterable. If the user changes any other product information in the window, however, the system modifies the database upon activation of the “Save” button; otherwise, the user may click the “Exit” button to return to the screen shown in FIG. 6A. The user may delete a product by clicking the “Delete” button. This changes the “Thru Date” field to the current date, rather than actually deleting a product value from the database.

Returning to FIG. 6A, the user may also export the data table to a spreadsheet, such as MICROSOFT EXCEL, by clicking the “Excel” button, thereby executing an export module (procedures 64, FIG. 1). Code structures suitable to export a formulated file into a spreadsheet should be understood in this art and are therefore not discussed in detail herein.

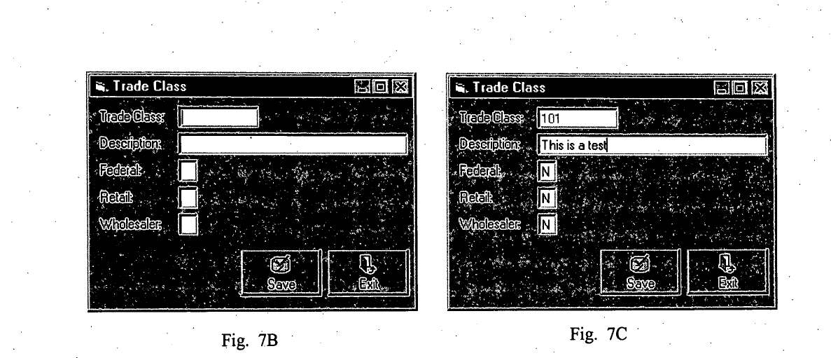

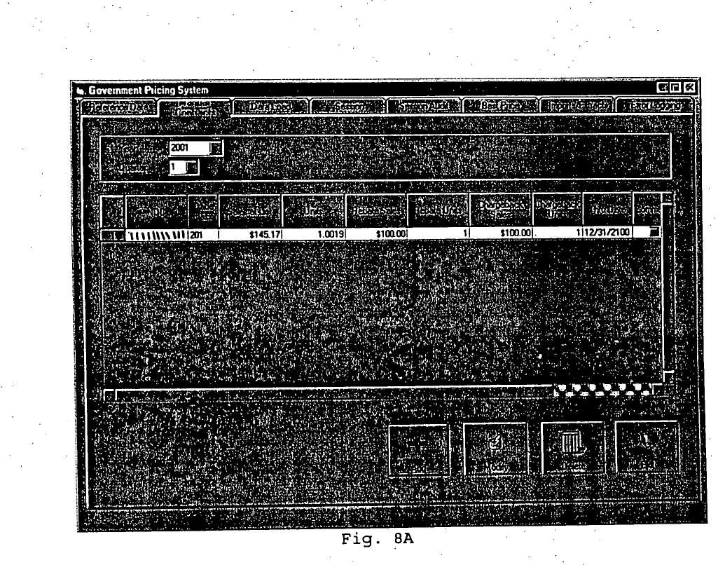

If the user clicks the “Trade Class” button shown in FIG. 2, the application displays a screen shown in FIG. 7A, through which the user may modify and add information related to trade classes in database Table B2. As described above, this user-defined data describes trade classes the systems expects to see when the system extracts data from peripheral systems. If an extract downloads data describing sales to trade classes not present in Table B2, the system so notifies the user by presenting the “Trade Class” button in FIG. 2 in a different color than that of the other buttons or by providing some other suitable indicator. Once the user reviews the trade class data, the button or other indicator changes to its default state. The window contains seven columns, “Trade Class,” “Description” “Federal,” “Retail,” “Wholesaler,” “From Date” and “Thru Date,” described above with respect to Table B2. The trade class definitions are valid from the “From Date” through the “Thru Date.”

To add a trade class, the user selects an “Add” button shown in FIG. 7A to load a window shown in FIG. 7B. This window allows the user to enter the trade class number and description and whether each of the “Federal,” “Retail” or “Wholesaler” columns should be set to “yes” or “no”. Once the user has entered the desired information, the “Save” button adds the information to database Table B2; otherwise, the user may select the “Exit” button to return to the window shown in FIG. 7A.

To modify any of the trade class definitions, the user selects the desired class in the “Trade Class” column in FIG. 7A, followed by the “Update” button, to load the window shown in FIG. 7C. The user may modify any of the displayed trade class data, except the trade class number. Upon entering the modified information, the user adds the data to the database by selecting the “Save” button; otherwise, the user may click the “Exit” button to return to the screen shown in FIG. 7A. The database retains the previous record, changing its “Thru” date to the current date. The user may delete a trade class selected in FIG. 7A by clicking the “Delete” button, thereby changing the selected trade class's “Thru Date” to the current date.

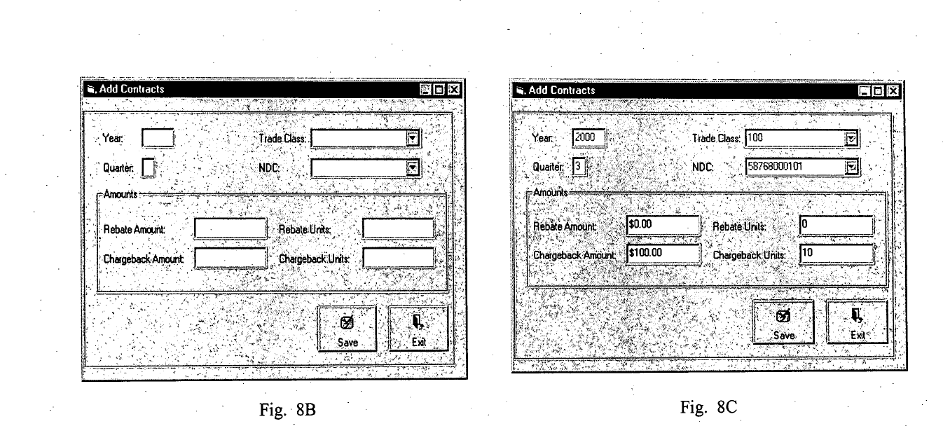

When the user clicks the “Manual Contracts” tab shown in FIG. 2, the application displays a screen shown in FIG. 8A. This interface allows the user to manually input contracts that have not been entered through the importing process previously described. To list data under existing manually-entered contracts, the user may select from a pop-up a particular year and fiscal quarter for which the user wishes to view contract data. The system then retrieves the data from Table A2 for all manual contracts in Table A2 and displays the data in the table shown in FIG. 8A. In another preferred embodiment, a similar tab screen provides the same information regarding contract information extracted from peripheral sources. For each contract, the table provides the contract purchaser's trade class, the products sold under the contract during the selected quarter, the number of those products sold at a rebate price, the rebate amount for the quarter, the number of products charged back to the vendor during the quarter, and the value of those charge backs.

To add an additional contract to Table A2, the user selects the “Add” button to load the screen shown in FIG. 8B. The user may enter the appropriate product (through its NDC code), trade class, contract time period and any rebate or charge back information. Once the user has entered the contract's information, the “Save” button adds the contract to the database in Table A2 and returns the user to the screen shown in FIG. 8A; otherwise, the user may click the “Exit” button to return to the screen shown in FIG. 8A. The contract's Load date is the current date, and its Thru date defaults to Dec. 31, 2100.

To modify contracts that have been manually entered, the “Modify” button loads a screen shown in FIG. 8C. The user may modify the rebate and charge back information for the selected contract but not the product's trade class, NDC, year or quarter. If the user modifies a record, the system retains the previous record, changing its “Thru” date to the current date. The “Save” button updates the database, or the “Exit” button returns the user to the screen shown in FIG. 8A. In a preferred embodiment, the user may delete a manual contract (or an extracted contract through a similar screen) by clicking a Delete button (not shown), thereby changing the selected contract record's “Thru” date to the current date.

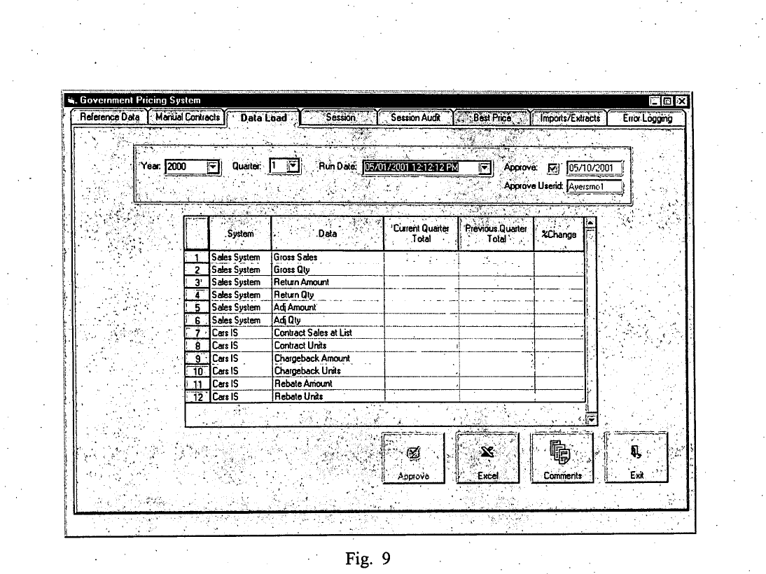

The “Data Load” tab shown in FIG. 2 loads the screen illustrated in FIG. 9, through which the user may review results of data extracts from peripheral systems such as the order-to-cash system and the contract management system (FIG. 1). The values displayed in the table are retrieved from database Tables A1, A2, A3 and/or A4, as controlled by Tables C1 and C2.

The system populates a record in Table C1 at the completion of each data extract. In the present embodiments, the system's extract modules retrieve data from the OTC and CMS for a requested calendar quarter and populate data records in Tables A1, A2 and A3 with data accumulated over the requested quarter. Thus, Table C1 identifies the applicable year and quarter for which the extract was performed. The Run Date is the date on which the extract occurred. Thus, upon selecting a year and a quarter in FIG. 9, the system populates a pull-down list with the run dates for the extracts performed for the selected year and quarter. Upon selecting a run date, the system populates the screen. Initially, before the user reviews and approves the extract, the “Approved” flag is blank, and the approval date and user fields are blank. The approval process, which changes these fields, is discussed below.

In another embodiment, the operator may view existing data by manually entering a “run date,” even if that date doesn't correspond to an actual run date. In this case, the system populates the screen in FIG. 9 with data, applicable to the selected quarter, from those database records where the entered run date is within a period defined from each record's Load date to its Thru date.

The data fields in Table C2 control how the system presents extracted data from Tables A1-A4 in the Data Load Screen that is summarized and shown in FIG. 9. Each record in Table C2 corresponds to a row in FIG. 9. In the present embodiment, these fields are hard-coded, but it should be understood that the user interface may include interface screens through which the user may define, modify and/or delete data load reports. Moreover, in another preferred embodiment, Table C2 is eliminated, and one or more tab screens are provided that display all the data in Tables A1 through A4 and that allow an operator to modify data records. Where a record is modified, the system creates a new record having a Load date equal to the current date and a Thru date of Dec. 31, 2100. The Thru date in the original record is changed to the current date.

Referring to Table C2 and FIG. 9, the “System” field describes the peripheral system from which the data described in the FIG. 9 row was extracted. The “Table” field points to the database table (A1, A2, A3 or A4 in this embodiment) for which the system draws data to display in FIG. 9, while “Field” points to the specific field in that table. “Data Order” establishes the record's row position in FIG. 9.

The system provides in FIG. 9 the quarter totals for the table fields specified in Table C2. For example, if a record in Table C2 points to the “Gross Quantity” field in Table A1, the system sums the values in that field for all records in Table A1 in the extract and places the sum in the “Current Quarter Total” column. It also displays the sum for the same field for the immediately preceding quarter in the “Previous Quarter Total” column and displays the percent change between the two values in the right hand column. The system arranges the records in FIG. 9 in rows according to the records' Data Order fields.

The user must “approve” a data extract before the new data will be eligible for session calculations. To approve an extract, the user clicks an “Approve” button. The system then prompts the user whether all manual contracts have been entered. If the user negatively responds, approval is suspended, and the user may enter manual contracts as discussed above. If the system determines that the extract includes any products not having an original record in Table B1 (the system automatically sets up a dummy record in the extract for any products or trade classes not already in the database and fills various data fields with easily-identifiable dummy variables), the system prompts whether the user wishes to go forward anyway. If the user negatively responds, approval is suspended, and the user may modify the dummy records in Table B1 for those products. If the system determines that the extract includes any trade classes not having a record in Table B2, the system prompts whether the user wishes to go forward anyway. If the user negatively responds, approval is suspended, and the user may modify corresponding dummy records in Table B2. If there is no CPI in Table B3 for the applicable year and quarter, the system suspends approval, and the user must enter an appropriate CPI record. If the approval process survives these hurdles, the system changes the status of the approval flag shown in FIG. 9 and listed in Table C2 and records the time at which approval occurred.

An “Excel” button allows the user to export the information in the FIG. 9 table to a spreadsheet. A “Comments” button displays a text field in which the user may enter any desired comments about the load data.

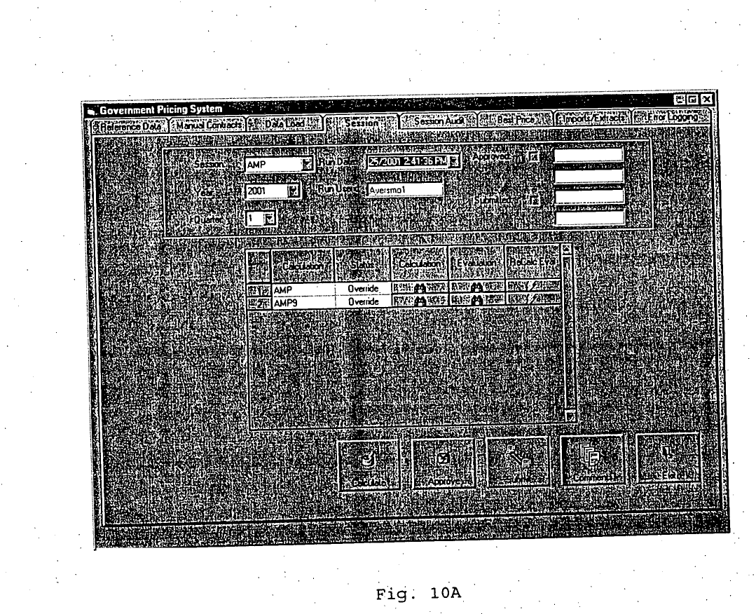

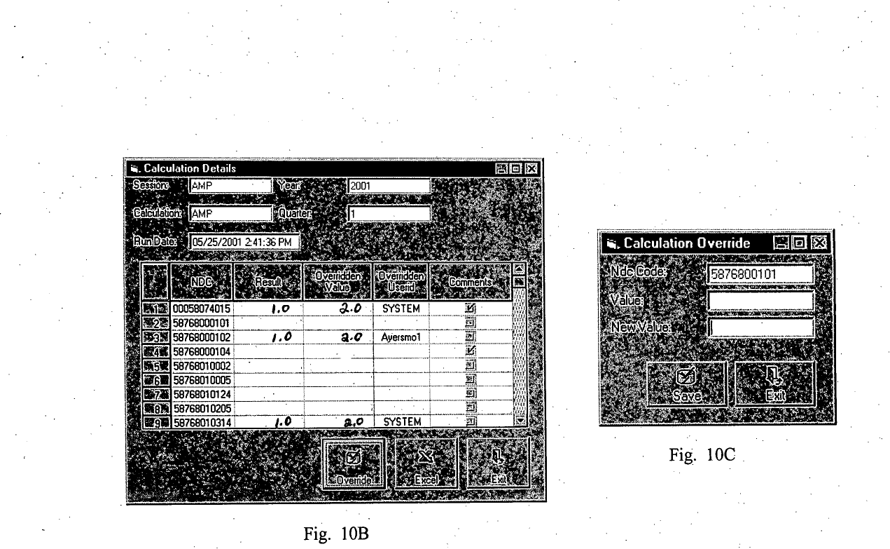

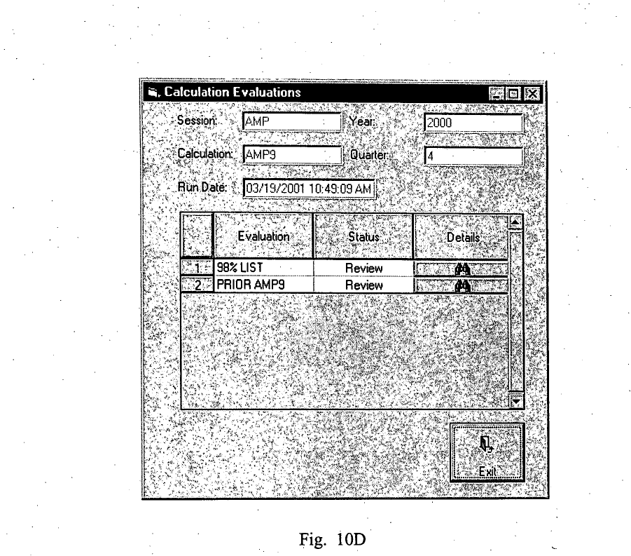

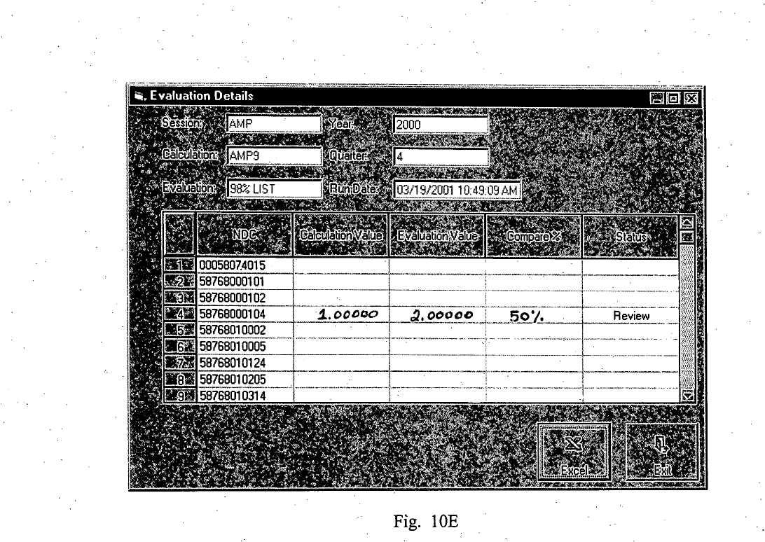

The “Session” tab from the screen shown in FIG. 2 loads a window illustrated in FIG. 10A through which the user may display and perform calculations, review and evaluate calculation results and approve sessions. A “session” generally corresponds in this embodiment to one or more calculations needed to complete a particular report. The session may execute an entire sequence of calculations or just part of the sequence. For example, a Medicaid report requires AMP, AMP9 and BP calculations, but the system requires that the user approve the AMP/AMP9 calculations before moving to BP. Thus, the system defines separate sessions for AMP/AMP9 and BP that the user runs separately from each other in preparing data for a Medicaid report. To prepare a VA report, however, the system defines a single session that executes all necessary calculations.

Session identifications are hard-coded into records in Table D1. Each session has an ID and description and is defined for a particular period. The system includes hard-coded links in Table D4 between session IDs (Table D1) and calculations. For example, suppose a particular session includes two calculations to be performed in a certain order. Table D4 therefore includes two records for the session ID, each specifying a respective one of the two calculations. The order in which the session executes the calculations is defined by the Calculation Order fields.

Each record in Table D4 defines an active time period between the “From” and “Thru” dates. By adding additional records for the same session ID for sequential time periods, session definitions may change to reflect regulatory changes. In one preferred embodiment, the user interface includes user screens through which the user may link calculations to session IDs, define session periods and/or modify existing session definitions.

The system populates a record in Table D2 each time a session executes. In the present embodiment, a session executes calculations for data covering a specific period of time, most often a calendar quarter, based on the calculation(s) involved. Thus, Table D2 identifies the applicable year and quarter over which the session was executed. Initially, the “Approved” flag is blank, and the approval date and user fields are blank. Similarly, the “Submit” data, which indicates whether session results have been submitted to reports, is blank. The approval and submission processes are described below.

Each session execution also creates multiple result records in Table D5. In the present embodiment, all calculations are specific to products. That is, if a calculation is applied to sales and pricing data for multiple products, the calculation provides results for each product based on each product's data. Thus, each record in Table D5, in addition to defining the session ID, calculation, year, quarter and run date, includes a field identifying the NDC code for the product for which the calculation result in the “Value” field applies. Initially, the “Overriden” fields are blank. The override procedure is discussed below.

To execute a session, or to review a previously executed session, the user selects the desired session from the session IDs in Table D1 in a “Session” pop-up list in FIG. 10A. The user also selects thecalendar quarter to which the session applies, and the system refers by default to the latest data extract for that quarter. In one preferred embodiment, the system does this by selecting all data records in which the current date falls within the records' Load and Thru dates. At this point, the “Run Date” field is blank, and the user may execute the selected session for the selected calendar quarter by clicking the “Calculate” button. The run date then becomes the current date. If, however, the user selects a run date in the Run Date list, the system populates the table in FIG. 10A with the data regarding results of the calculations linked to the selected session in Table D4. If a user has previously approved the session, the “Approved” box displays a check mark, otherwise it is blank. Only non-approved sessions can be re-executed.

The user may manually enter the run date. In this case, the system compares the entered date with the Load and Thru dates of all data extracts in the database for the selected calendar quarter. As discussed above, multiple data extracts in a given quarter will have effective periods (defined by their Load and Thru dates) that extend successively through the quarter. Additionally, manual contracts may be entered and/or modified independently of the extracts and may therefore have effective periods different from the extracted data records. Similarly, in those embodiments in which other data records are manually modifiable, such modified data records may also have different effective periods.. The system selects those records, whether extracted or manually entered or modified, applicable to that quarter having Load and Thru dates within which the entered run date falls.

Thus, the set of product sales data used by a session may differ from session to session for the same selected quarter, depending on the selected run date. Since the system selects those date records where the selected run date falls between the records' Load and Thru dates, the selected run date may distinguish among different data extracts for the selected quarter. Furthermore, where data is added or modified following one extract and before the next, different run dates between the two extracts may result in different data sets where the run dates are on opposite sides of the additions or modifications. Since the run date is stored with the session results and since the database maintains the data records with their Load and Thru dates, the data set used for any stored session may be identified.

To execute the calculations attached to the session in Table D4, whether the session is new or is previously stored but not approved, the user activates a “Calculate” button in FIG. 10A. If the user has not yet approved the data extract for the specified calendar quarter, the system so notifies the user and suspends the calculation. The user may then approve the data as described above and recalculate. If the data extract is approved, the system notifies the user that the calculation will write over any existing calculation results (Table D5) for that session in that quarter. In response, the user may discontinue the session or continue. If the user continues, the session executes, and the system stores the session's calculation results in Table D5.

Once the session is complete, or if the user has retrieved an existing session, the user may approve the session results by activating an “Approve” button in FIG. 10A. At this point, the session cannot be recalculated for that calendar quarter. If the user does not approve the session and later recalculates the session, the system deletes the original, unapproved, session results.

A “Comments” button in FIG. 10 allows the user to enter any desired comments. Comments are stored in Table D3.

To review the results of a particular calculation for a given session run, the user retrieves the session into the screen shown in FIG. 10A and clicks the “Calculation” binoculars tab in the row corresponding to the desired calculation. This brings up a screen, shown in FIG. 10B, that displays the session's result data from Table DS for the selected calculation and calendar quarter. The two left hand columns in Table 10B display the product NDC code and result value for each applicable record in Table D5. The “Overridden Value” and “Overridden Userid” are zero and blank, respectively, unless the user has manually changed any result data. As noted above, such changes are allowed only if the session has not be approved.

If the calculation data has not been approved, the user may change a Result field for a given product by highlighting the desired field and clicking the “Override” button in FIG. 10B to produce the screen in FIG. 10C. When the user enters a new value in FIG. 10C and clicks the “Save” button, the system puts the new value in the appropriate field in the Result column in FIG. 10B and moves the originally calculated value to the “Overridden Value” column in the same row. The database stores the values in the Value and Overridden Value fields, respectively, of Table D5. If the user overrides the same field a second time, the system replaces the first “new” value with the second “new” value in the Result column. The originally calculated value remains in the “Overridden Value” column and is not deleted. If the user decides not to override a value in the FIG. 10C screen, clicking the “Exit” button returns the user to the screen in FIG. 10B. The user may also click an “Excel” button to export the data in the calculation details screen to a spreadsheet. The user may use a Comments button to insert explanations regarding why particular values have been overridden. Finally, the system records the user's identification for any override.

It may be desirable to compare a calculation result to some benchmark related to the result. For example, a vendor may wish to determine how a product's current best price differs from its best price for the same quarter the previous year. Accordingly, the present system defines evaluation algorithms that may be applied to calculation results to provide the desired information.

More specifically, evaluation algorithms defined in Table D10 compare calculation results to current or historical product data or calculation results. Each record in Table D10 includes an Evaluation ID that identifies the evaluation algorithm and that is used in Table D9 to link the evaluation to one or more calculations. That is, the system applies the evaluation algorithm defined in Table D10 against the results of each calculation to which the evaluation is linked in Table D9. In the present embodiment, the links in Table D9 are hard-coded, although it should be understood that the user interface may include interface screens through which a user may selectively define, delete or modify such links. Each record also includes a description of the evaluation, such as “Comparison of Current BP to Prior Year BP.”

In the present embodiments, the “Test ID” field in Table D10 defines the base value against which the calculation result is compared: (1) “List”—comparison of the calculation result to the applicable product's list price; and (2) “Calc”—comparison of the calculation result with another (secondary) calculation result. It should be understood, however, that other comparison benchmarks could be used.

“Compare Calculation” defines the secondary calculation. This field is ignored, and may therefore be left blank, when Test ID is “List.”

“Compare Quarter” defines the look back period at which to select the benchmark value. In the present embodiment, Compare Quarter ranges from 0 to 4. That is, the evaluation may compare the calculation result to a present benchmark value or to a benchmark value up to one year old. For example, where Test ID is “List” and Compare Quarter is 0, the system compares the calculation's result against the applicable product's. present list price. Where Test ID is “Calc,” Compare Calculation is AMP and Compare Quarter is 4, the system compares the calculation's result against the AMP result for the same product for the same quarter the prior year.

The system determines the status of a comparison through criteria defined by “Operator ID” and “Compare Percent.” Operator ID can be one of four operators: “RN” (range), “ET” (equal to), “LT” (less than) or “GT” (greater than). Compare Percent is a percent applied to the benchmark value prior to application of the Operator. ID. For example, where Test ID is “List,” Compare Quarter is 1, Operator ID is RN and Compare Percent is 0.2, the system sets the evaluation status as “pass” if the calculation's result is within 20% of the applicable product's list price for the prior quarter. If the comparison is beyond 20%, the status is “review.” Where Test ID is “Calc,” Compare Calculation is AMP, Compare Quarter is 0, Operator ID is GT and Compare Percent is 0.9, the system sets the evaluation status as “pass” if the calculation's result is greater than 90% of the AMP result for the same product for the same quarter.

The system automatically executes the evaluations defined in Table D9 each time a session is calculated. Evaluations may be used to alert the user of possibly incorrect. calculation results. In this event, the user may override the calculation result and re-execute the evaluation by activating a “recalculation” button.

The system stores each evaluation report as a record in database Table D7. The record includes the session identification and run date, the calculation identification, and the session year and quarter. Because calculations in the present embodiment, and therefore evaluations, are specific to products, the record also defines the applicable NDC code. The last four fields store evaluation results. The Value field is the calculation result being evaluated against the benchmark. “Compare Value” is the benchmark value (in this case either list price or a secondary calculation result for the same product) for the quarter defined by the Compare Quarter field in Table D10. “Percent Change” is the percent difference between the Value and Compare Value numbers, and “Status” is the evaluation status.

Referring again to FIG. 10A, an “Evaluation” button in each calculation row loads a window as in FIG. 10D that displays the evaluation(s) linked to that calculation in Table D9. If the evaluation of the calculation's result for any product creates a “review” status, the evaluation status shown in FIG. 10D for the applicable evaluation is “review.” If the status for all product results is “pass,” the evaluation status shown in FIG. 10D is “pass.”

Activation of the “Detail” button in a given row in FIG. 10D displays a screen shown in FIG. 10E that provides the evaluation. results in the last four fields of the corresponding record in Table D7. For example, and referring to FIGS. 10A, 10D and 10E, the AMP session includes two calculations—AMP and AMP9. The AMP9 calculation is tied to two evaluations in Table D9—98% LIST and PRIOR AMP9. For the execution of the AMP9 calculation in the AMP session run on Mar. 19, 2001 against fourth quarter, 2000, both evaluations bring back a “review” status. For product 58768000104, the AMP9 calculation result was 1, the benchmark value was 2, and the result value as a percent of the benchmark value is 50%. It should be understood that these values are provided for purposes of example only.

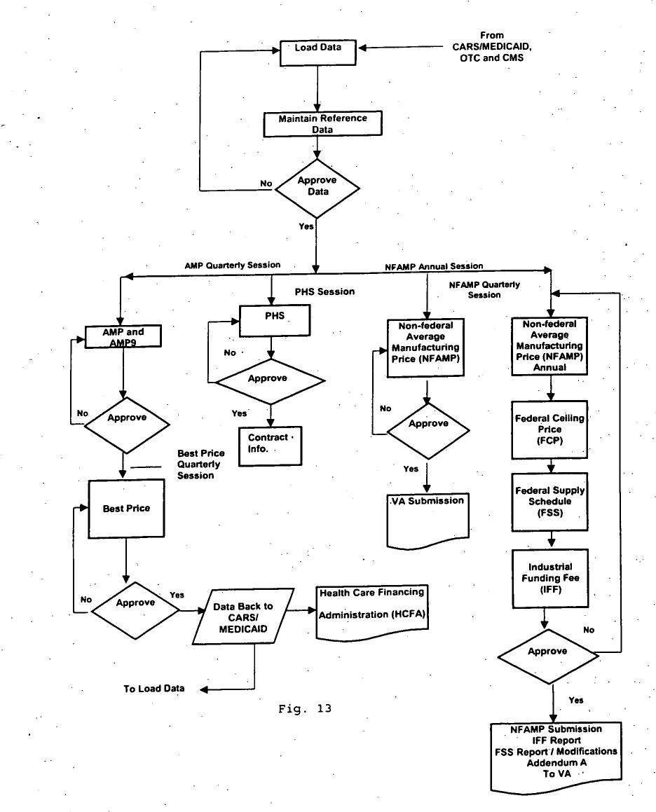

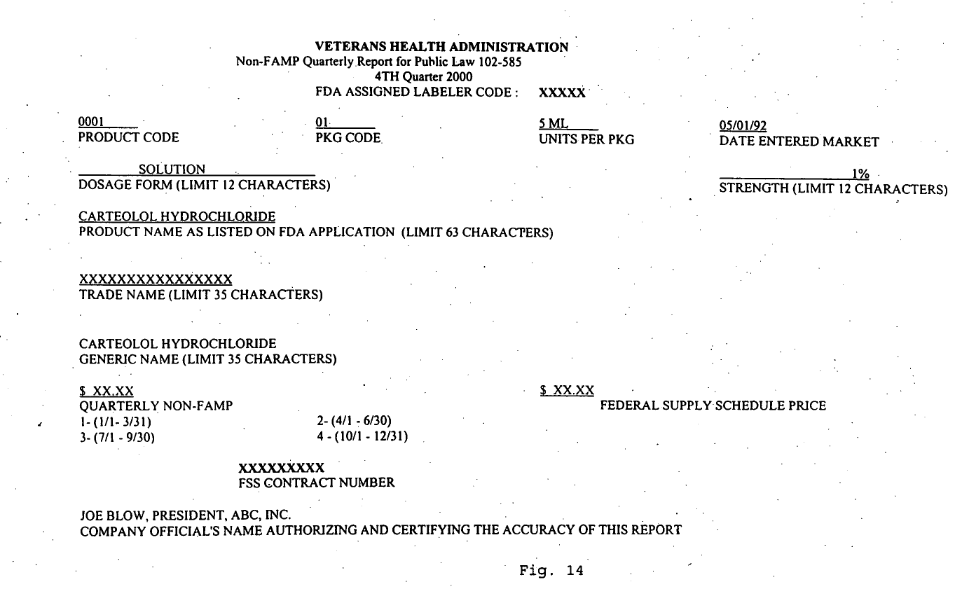

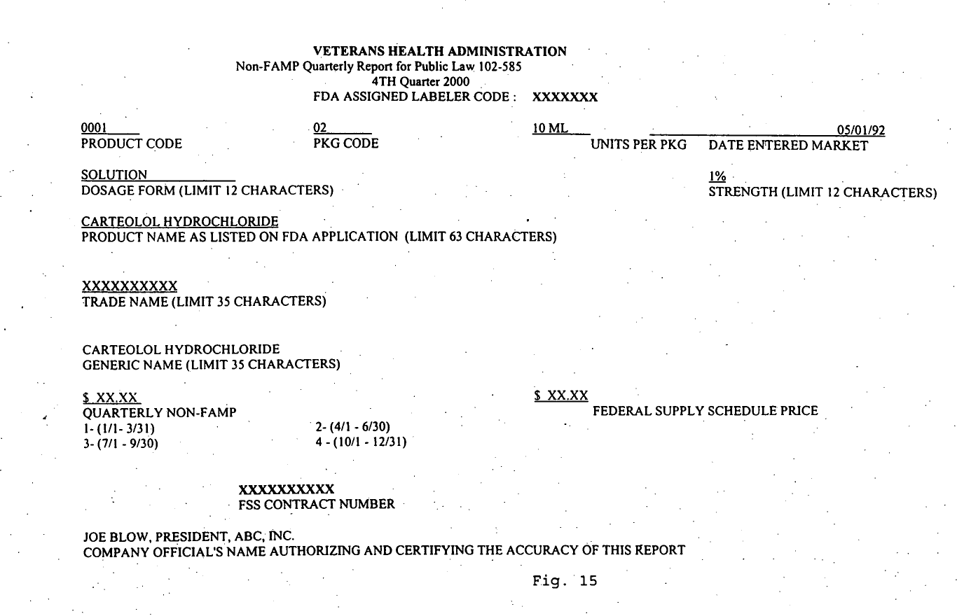

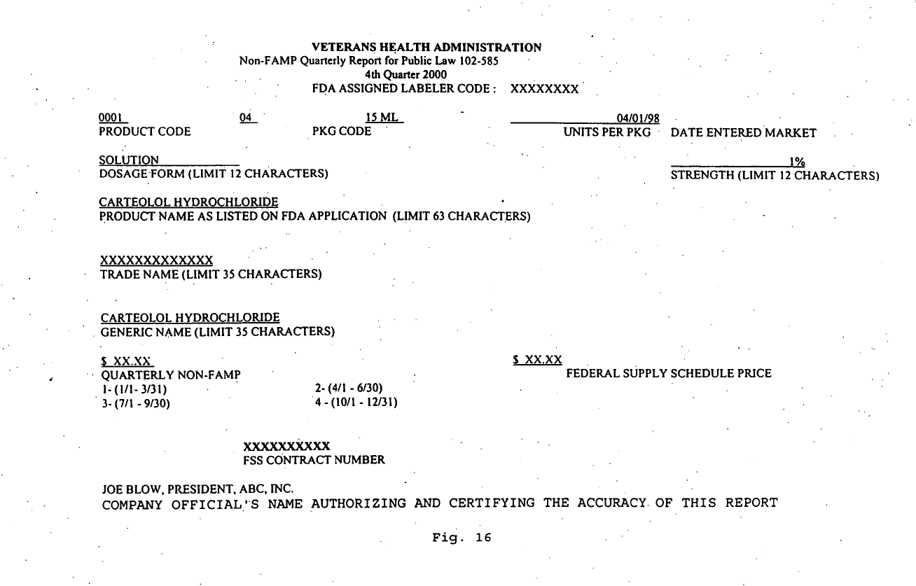

The system may communicate evaluation data in various manners. An “Excel” button, for example, exports the data in FIG. 10E to a spreadsheet. Moreover, and returning to FIG. 10A, the session's calculation results may be submitted to a government agency by clicking the “Submit” button. System 10 (FIG. 1) includes a software module that generates a VA report (e.g. as shown in FIGS. 14-16) by correlating values from the above-described database tables into report formats coded in the modules. In the present embodiment, Medicaid System 40 (FIG. 1) prepares HCFA reports, relying in part on the AMP and BP values provided by the present system, but it should be understood that system 10 (FIG. 1) may include a module to report data directly to HCFA, as indicated in FIG. 13. The system may print out hard copy reports for manual submission or may electronically transmit the report via e-mail, a dedicated link or other suitable electronic transmission means. Those skilled in the art should be familiar with the creation of reports through computer programming and the electronic transmission of such reports. Thus, generation and transmission modules are not discussed in detail herein.

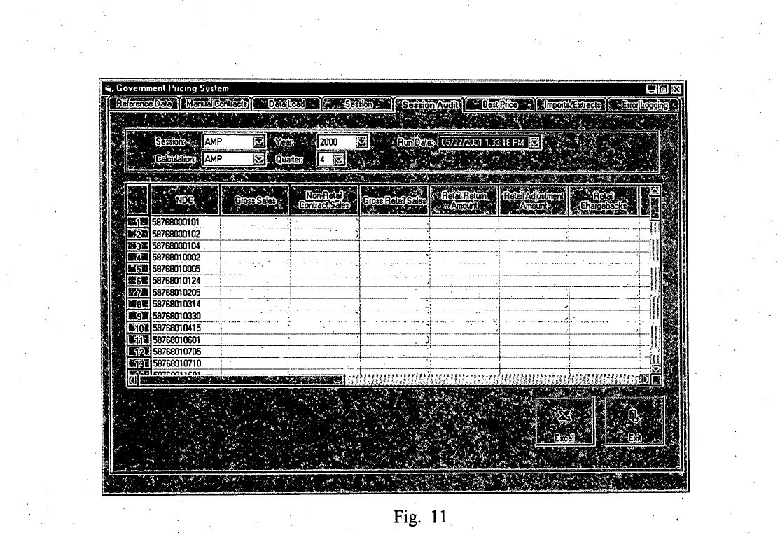

If the user clicks the “Session Audit” tab in FIG. 2, the application displays the screen shown in FIG. 11. This interface allows the user to display the intermediate steps of the calculations executed in a given session run. That is, each FIG. 11 window relates to a specific calculation in a specific session run, as identified by the session and calculation identifiers, year, quarter and run date selected in the appropriate pop-up lists. The table window displays, for each product, each data value and each intermediate calculated value used in determining the calculation result for the product. These data and calculation values are discussed above, and the specific columns for the various calculation windows in FIG. 11 are therefore not discussed herein. The tables in FIG. 11 may be exported to a spreadsheet by clicking the “Excel” button.

Session audit data is stored in Table D6. For each product used in each calculation in each session run, Table D6 includes a record (the “Value” field) for each result value and intermediate calculated value. The “Sequence” field establishes where the value appears in the audit screen in FIG. 11.

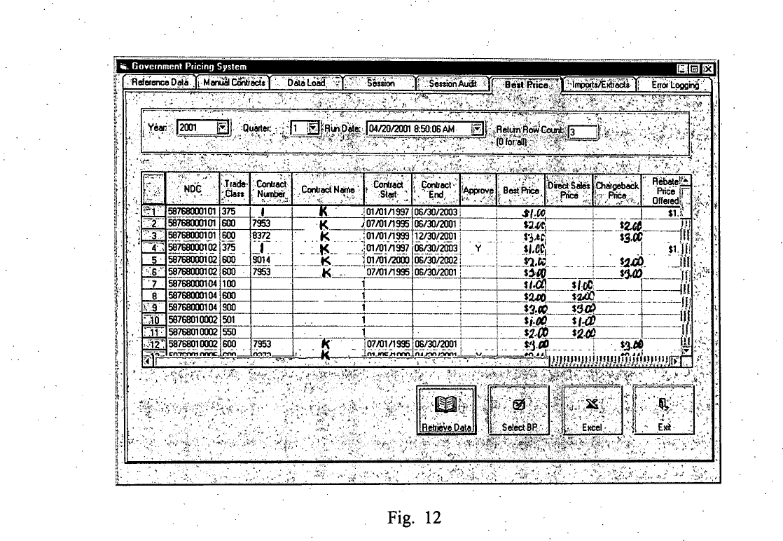

The “Best Price” tab in FIG. 2 loads the screen shown in FIG. 12. This interface allows the user to approve and/or change the best price, as initially determined by the system, for products sold under contracts stored in the database. As discussed above, the best price algorithm applies to pricing data provided in Table A3. For sales of a given product to a given trade class in a given calendar quarter, Table A3may contain up to five price records, each describing one of five prices for the product: list price, rebate price offered, rebate price taken, charge back price and direct sales price. Table A5 lists each of these price types and the order in which they appear in the screen shown in FIG. 12. That is, the Price Type field in Table A3 links a price type from Table A5 to the price value in each record in Table A3.

To execute a best price worksheet prior to a best price session, the user accesses the tab screen shown in FIG. 12 and selects the desired year and quarter in the appropriate pop-up lists. Since best price is determined for a data extract, the user also identifies the extract run date from a pop-up list of all extract dates (Load Dates) in Table A3. Upon activation of a “Retrieve Data” button, the system selects those NDCs having an “s” or “i” calculation indicator in Table B1, excluding pricing data records in Table A3 for any contracts. linked to best price in Table B5. The surveys the prices (the ML Price fields in Table A3) for all data records for each of these products (by eleven-digit NDC), regardless of trade class or contract, and selects a group of lowest prices for each product. The number of prices in the group is determined by the Return Row Count field, which is entered by the user prior to executing the session. That is, if the Return Row Count is 1, the system selects the lowest product price. If Return Row Count is 2, the system selects the two lowest prices. Referring to FIG. 12, for example, the Return Row Count is 3, and the system displays three rows in the tab screen for each product, listed in ascending price order. For product number 587680000101, the absolute best price is $1.00, an offered rebate price. The next two lowest prices, $2.00 and $3.00, are charge back prices. (The columns for rebate price taken and list price do not appear in FIG. 12 but are to the right of rebate price offered.) It should be understood that these prices are for purposes of illustration only and do not represent actual prices.

The Return Row Count addresses the problem of nominal prices. That is, some prices might not be valid, for example where a product is offered at an unusual, or nominal, discount. Accordingly, setting the Return Row Count at a value greater than 1 increases the likelihood that the best price data retrieval will return a valid best price for a given product.

The best price table in FIG. 12 includes a “Best Price” column in which is repeated the best price value from one of the four price type columns. Upon populating the price table, the system updates Table A3, establishing a new data record in Table A3 for each row in the best price table in FIG. 12. The ML Price in each new record is the price value in the corresponding row, and the price type is “B.” The “Thru” date for each new record defaults to Dec. 31, 2001.

The system selects the lowest price among the values in the table's Best Price column as the overall nine-digit NDC product family best price and sets the flag in the “Approve.” column for that price to “Y.” If the user approves of system's choice, the user activates the “Select BP” button. This also updates the data record in Table A3 for the new “B” price type record for that price value, setting the record's Approval Flag to “Y.” Alternatively, the user may change the overall product family best price by clicking on the space in the “Approve” column for that price. This moves the “Y” from the original row to the selected row. Activation of the “Select BP” button updates the approval flag for the appropriate record in Table A3.

The best price worksheet being complete, the best price session is used to identify best prices in data extracts. This algorithm selects, for each product family, the price having a B price type and a Y approval flag and establishes a record for that price in Table D5. If the user executes the BP calculation for a different data extract over the same calendar quarter, the system stores the new best price in a record in Table D5 and changes the Thru date for the previous record to the present date. This is the best price for all eleven-digit NDC's within the nine-digit NDC family.

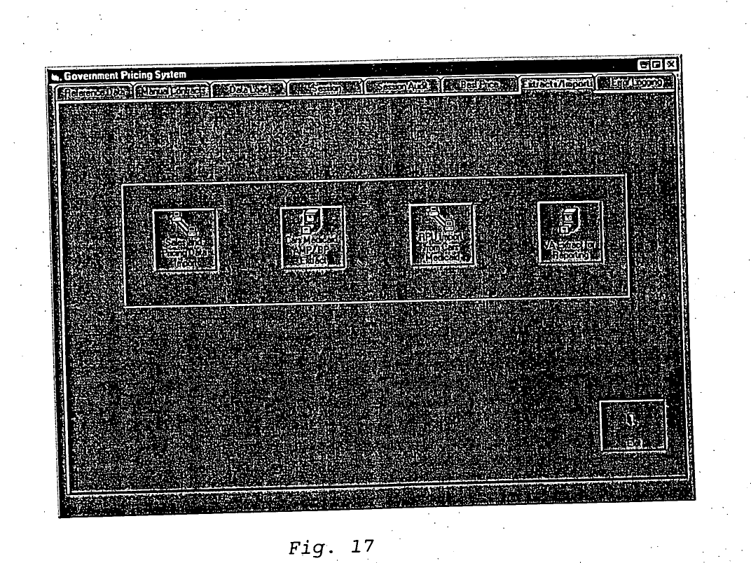

Upon activating the “Extracts/Imports” tab in FIG. 2, the system loads a screen shown in FIG. 17, from which the user may execute extraction and report modules. A “Sales and Pricing Data Import” button loads a screen (not shown) that provides pop-up lists for year and quarter. Activation of an “OK” button executes a data extraction module that extracts data from peripheral devices and populates the system's data fields, as discussed above. A similar screen is presented upon activation of the “Cars Medicaid AMP/BP Extract” button. After the user selects a desired calendar quarter and activates an “OK” button, the system selects the BP and AMP values for the selected quarter, provided the corresponding session results have been approved, and stores the data in a file that is later imported into CARS/MEDICAID. If the. BP and AMP data has not been approved, the system so notifies the user and suspends the download.

After CARS/MEDICAID retrieves the BP and AMP data and generates RPU values, the user may activate the “RPU Import from Cars Medicaid” button and select the desired calendar quarter from a resulting screen (not shown). Activation of a “Goto” button executes an extraction module that downloads the RPU data from CARS/MEDICAID into the system.

A “VA Extract for Reporting” button presents a screen (not shown) at which the user selects a desired calendar quarter and executes a report module that populates the VA report shown in FIGS. 14-16 for the selected quarter.

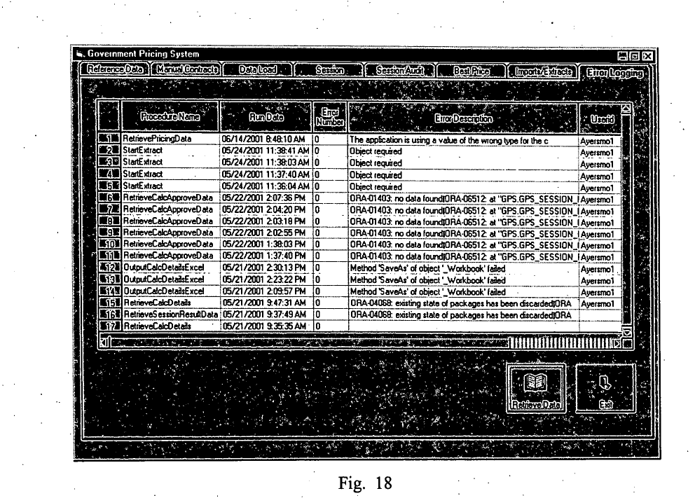

Upon selection of the “Error Logging” tab in FIG. 2, the system displays a screen shown in FIG. 18 that lists system errors and errors resulting from the most recent data extract.

FIG. 13 illustrates operation of the system described above. First, system extraction modules download product sales data into the system database from the order-to-cash system and the contract management system. The user may next modify certain reference data and approve the data load. In the illustrated embodiment, the system defines five session options: quarterly AMP, quarterly BP, quarterly NonFAMP, annual NonFAMP and PHS. That is, the system includes five sessions, where each session includes one or more calculations that operate against product-specific sales and pricing data.

As described above, the user may base the approval decision on session evaluations. In one preferred embodiment, for example, the system defines an evaluation for BP calculations that compares the best price result to the AMP9 result for each nine-digit product family. The evaluation passes if the BP is less than or equal to AMP9. If not, the evaluation result is “review.” The user may, in response, wish to change the BP value and re-evaluate prior to approving the session.

The quarterly AMP session is run in tandem with the quarterly BP session. That is, the user independently executes each of these sessions for the desired quarter. If the user approves each session's results, the application has determined the average manufacturing price and the best price for each eleven-digit NDC product,.which may then be exported in a report to the HCFA.

If the user wishes to perform a quarterly non-federal average manufacturing price session, the application executes the pre-defined calculations described above that determine the non-federal average manufacturing price information. If the user approves the session results, the user may then submit the information in report form to the Veterans Administration.

The Annual NonFAMP session links to the NonFAMP, FCP, FSS and IFF calculations in the sequence shown in FIG. 13. If the user executes this session, the application executes the pre-defined calculations in order. The user may submit the resulting information in a report to the Veterans Administration.

While one or more preferred embodiments of the invention have been described above, it should be understood that any and all equivalent realizations of the present invention are included within the scope and spirit thereof. For example, those skilled in the art should appreciate that the timing tags described above, e.g. the Load and Thru date pairs associated with the data load tables, the From and Thru date pairs associated with the reference data, and the Run dates associated with the session results, are not the only suitable tags or timing tags and, moreover, are not the only mechanism for maintaining data for audit. For example, each record may be saved with a single field (as opposed to two fields) that establish storage sequence, or entire blocks of data may be stored with a suitable tag, or other identifier or mechanism that separates one data set from another. Thus, the embodiments depicted are presented by way of example only and are not intended as limitations upon the present invention, and it should be understood by those of ordinary skill in this art that the present invention is not limited to these embodiments since modifications can be made. Therefore, it is contemplated that any and all such embodiments are included in the present invention as may fall within the literal or equivalent scope of the appended claims.

### Appendix

TABLE A1
Sales

| | |
|---|---|
| SetId: | VARCHAR2(5) |
| Year: | NUMBER |
| Quarter: | NUMBER |
| NDC_Code: | VARACHAR2(15) |
| Trade_Class_id: | VARCHAR2(10) |
| Thru_date: | DATE |
| Gross_QTY: | NUMBER (15, 4) |
| Gross_Sales: | NUMBER (15, 4) |
| Adj_Qty: | NUMBER (15, 4) |
| Adj_Amount: | NUMBER (15, 4) |
| Return_Qty: | NUMBER (15, 4) |
| Return Amount: | NUMBER (15, 4) |
| Load_date: | DATE |

TABLE A2
Contract_Sales

| | |
|---|---|
| SetId: | VARCHAR2(5) |
| Year: | NUMBER |
| Quarter: | NUMBER |
| NDC_Code: | VARACHAR2(15) |
| Trade_Class_id: | VARCHAR2(10) |
| Thru_date: | DATE |
| Contract_Sales_List: | NUMBER (15, 4) |
| Contract_Units: | NUMBER (15, 4) |
| Rebate_Amount: | NUMBER (15, 4) |
| Rebate_Units: | NUMBER (15, 4) |
| Chargeback_Amount: | NUMBER (15, 4) |
| Chargeback_Units: | NUMBER (15, 4) |
| Comment_Sequence: | NUMBER |
| Manual_Flag: | CHAR(1) |
| Load_date: | DATE |

TABLE A3
Price

| | |
|---|---|
| SetId: | VARCHAR2(5) |
| Year: | NUMBER |
| Quarter: | NUMBER |
| NDC_Code: | VARACHAR2(15) |
| Trade_Class_id: | VARCHAR2(10) |
| Contract_Number: | VARCHAR2(40) |
| Price_Type: | VARCHAR2(3) |
| Thru_date: | DATE |
| Contract_Start_Date: | DATE |
| Contract_End_Date: | DATE |
| Contract_Name: | VARACHAR2(30) |
| Price: | NUMBER (15, 4) |
| ML_price: | NUMBER (15, 4) |
| Package_size: | NUMBER |
| Approval_Flag: | CHAR(1) |
| Load_date: | DATE |

TABLE A4
NDC_Units

| | |
|---|---|
| SetId: | VARCHAR2(5) |
| Year: | NUMBER |
| Quarter: | NUMBER |
| NDC_Code: | VARCHAR2(15) |
| Program_Type: | CHAR(18) |
| Cumulative_Units_Paid: | NUMBER (15, 4) |
| Rebate_Per_Unit: | NUMBER (15, 4) |
| Load_date: | DATE |

TABLE A5
Price_Type

| | |
|---|---|
| Price_Type: | VARCHAR2(3) |
| Description: | VARCHAR2(40) |
| Price_Order: | NUMBER |

TABLE B1
Product_Master

| | |
|---|---|
| NDC_Code: | VARCHAR2(15) |
| Thru_Date: | DATE |
| Description: | VARCHAR2(40) |
| Calculation_Ind: | CHAR(1) |
| Drug_Catg_Id: | CHAR(1) |
| HCFA_Medicaid_Expiry_Date: | DATE |
| VA_Discontinue_Date: | DATE |
| UOM: | VARCHAR2(10) |
| Package_Size: | NUMBER |
| From_Date: | DATE |

TABLE B2
Trade_Class

| | |
|---|---|
| Trade_Class_Id: | VARCHAR2(10) |
| Thru_Date: | DATE |
| Description: | VARCHAR2(40) |
| Federal_Flag: | VARCHAR2(1) |
| Retail_Flag: | VARCHAR2(1) |
| Wholesaler_Flag: | VARCHAR2(1) |
| From_Date: | DATE |

TABLE B3
Consumer_Price_Index

| | |
|---|---|
| Year: | NUMBER |
| Thru_Date: | DATE |
| CPI_U: | NUMBER (5, 4) |
| From_Date: | DATE |

TABLE B4
Calc_Exception

| | |
|---|---|
| NDC_Code: | VARCHAR2(15) |
| Calc_ID: | VARCHAR2(10) |
| Trade_Class_Id: | VARCHAR2(10) |
| Thru_Date: | DATE |
| From_Date: | DATE |

TABLE B5
Calc_Contract

| | |
|---|---|
| Calc_ID: | VARCHAR2(10) |
| Thru_Date: | DATE |
| From_Date: | DATE |
| Contract_Number: | VARCHAR2(40) |

TABLE C1
Data_Load

| | |
|---|---|
| Year: | NUMBER |
| Quarter: | NUMBER |
| Thru_Date: | DATE |
| Run_Date: | DATE |
| Approved_Flag: | CHAR(1) |
| Approved_Date: | DATE |
| Approved_Userid: | VARCHAR2(10) |
| Comment_Sequence: | INTEGER |

TABLE C2
Data_Variance

| | |
|---|---|
| System: | VARCHAR2(40) |
| Data_Source: | VARCHAR2(40) |
| Table_Name: | VARCHAR2(40) |
| Field_Name: | VARCHAR2(40) |
| Data_Order: | NUMBER |

TABLE D1
Session

| | |
|---|---|
| Session_ID: | VARCHAR2(10) |
| Thru_Date: | DATE |
| From_Date: | DATE |
| Description: | VARCHAR2(40) |

TABLE D2
Session_Result

| | |
|---|---|
| Session_ID: | VARCHAR2(10) |
| Year: | NUMBER |
| Quarter: | NUMBER |
| Run_Date: | DATE |
| Approved_Flag: | CHAR(1) |
| Approved_Date: | DATE |
| Approved_Userid: | VARCHAR2(10) |
| Submit_Flag: | CHAR(1) |
| Submit_Date: | DATE |
| Submit_Userid: | VARCHAR2(10) |
| Comment_Sequence: | INTEGER |
| Run_Userid: | VARCHAR2(10) |

TABLE D3
Comment

| | |
|---|---|
| Comment_Sequence: | INTEGER |
| Comment_Text1: | VARCHAR2(80) |
| Comment_Text2: | VARCHAR2(80) |
| Comment_Text3: | VARCHAR2(80) |
| Comment_Text4: | VARCHAR2(80) |

TABLE D4
Session_Calc

| | |
|---|---|
| Session_ID: | VARCHAR2(10) |
| Calc_ID: | VARCHAR2(10) |
| Calc_Order: | NUMBER |
| Thru_Date: | DATE |
| From_Date: | DATE |

TABLE D5
Session_Calc_Result

| | |
|---|---|
| Session_ID: | VARCHAR2(10) |
| Calc_ID: | VARCHAR2(10) |
| Year: | NUMBER |
| Quarter: | NUMBER |
| NDC_Code: | VARCHAR2(15) |
| Run_Date: | DATE |
| Value: | NUMBER (15, 4) |
| Overriden_Value: | NUMBER (15, 4) |
| Overriden_Userid: | VARCHAR2(10) |
| Comment_Sequence: | INTEGER |

TABLE D6
Session_Audit

| | |
|---|---|
| Session_ID: | VARCHAR2(10) |
| Calc_ID: | VARCHAR2(10) |
| Year: | NUMBER |
| Quarter: | NUMBER |
| NDC_Code: | VARCHAR2(15) |
| Run_Date: | DATE |
| Sequence: | NUMBER |
| Description: | VARCHAR2(40) |
| Value: | NUMBER (15, 4) |

TABLE D7
Session_Eval_Result

| | |
|---|---|
| Session_ID: | VARCHAR2(10) |
| Calc_ID: | VARCHAR2(10) |
| Eval_ID: | VARCHAR2(10) |
| Year: | NUMBER |
| Quarter: | NUMBER |
| NDC_Code: | VARCHAR2(15) |
| Run_Date: | DATE |
| Value: | NUMBER (15, 4) |
| Compare_Value: | NUMBER (15, 4) |
| Percent_Chg: | NUMBER |
| Status: | CHAR(1) |

TABLE D8
Calculation

| | |
|---|---|
| Calc_ID: | VARCHAR2(10) |
| Description: | VARCHAR2(40) |
| Procedure_Name: | VARCHAR2(40) |
| Thru_Date: | DATE |
| From_Date: | DATE |

TABLE D9
Cal_Evaluation

| | |
|---|---|
| Calc_ID: | VARCHAR2(10) |
| Eval_ID: | VARCHAR2(10) |
| From_Date: | DATE |
| Thru_Date: | DATE |

TABLE D10
Evaluation

| | |
|---|---|
| Eval_ID: | VARCHAR2(10) |
| Description: | VARCHAR2(40) |
| Test_id: | VARCHAR2(20) |
| Operator_id: | CHAR(2) |
| Compare_Percent: | NUMBER |
| Compare_Calc: | VARCHAR2(10) |
| Compare_Quarter: | NUMBER |
| From_Date: | DATE |
| Thru_Date: | DATE |

What is claimed is:

1. In preparing predetermined information relating to product sales, as required by a regulatory entity not a party to the sales, from product sales data describing the sales maintained in one or more external computer and/or database systems, where the product sales data at least describes products sold, prices at which the products were sold, adjustments to sales of the products and parties to which the products were sold, and where the information is derived from the product sales data through one or more predetermined algorithms, a computerized method of acquiring and managing the product sales data, said method comprising the steps of:
receiving a first set of said product sales data from said one or more external systems;
storing said first product sales data set;
replacing or modifying said first product sales data set, while maintaining said first product sales data as it existed prior to said replacing or modifying step so that it is distinguishable from said replaced or modified product sales data set (“second product sales data set”);
selecting one of said first product sales data set and said second product sales data set;
executing said one or more algorithms upon said product sales data set selected at said selecting step; and
storing a first set of said information derived at said executing step.

2. The method as in claim 1, including
repeating said selecting and executing steps for the other of said first product sales data set and said second product sales data set, and
storing a second set of said information derived at said repeated executing step, while maintaining said first information set as it existed following said first executing step.

3. The method as in claim 1, wherein said first storing step includes storing said first product sales data set in association with a first timing tag, said first timing tag being related to a time at which said first product sales data set is received.

4. The method as in claim 3, wherein said timing tag includes a time at which said first product sales data set is received (“first store time”) and a first expiration time.

5. The method as in claim 4, wherein said first expiration time defaults at said first storing step to a date substantially beyond said first store time.

6. The method as in claim 4, wherein said replacing or modifying step includes storing said second product sales data set with a second timing tag, said second timing tag being related to a time at which said first product sales data set is replaced or modified.

7. The method as in claim 6, wherein said second timing tag includes a time at which said first product sales data set is replaced or modified (“second store time”) and a second expiration time, and wherein said replacing or modifying step includes changing said first expiration time to equal said second store time.

8. The method as in claim 7, wherein said selecting step includes selecting a desired time and selecting said product sales data set having an effective period, said effective period being defined by said store time and said expiration time of said product sales data, within which said desired time falls.

9. The method as in claim 3, wherein said first product sales data set includes a plurality of data records, and wherein each said data record includes a said first timing tag.

10. The method as in claim 1, wherein said replacing or modifying step includes receiving said second product sales data set from said one or more external system.

11. The method as in claim 1, wherein said first product sales data describes said sales occurring over a predetermined period of time, and wherein said second product sales data set describes said sales occurring over the same said predetermined period as said first product sales data set.

12. The method as in claim 11,
wherein said second storing step includes storing said first information set in association with a first timing tag, said first timing tag being related to a time at which said first information set is derived at said executing step,
wherein said method includes repeating said selecting and executing steps for the other of said first product sales data set and said second product sales data set, and storing a second set of said information derived at said repeated executing step in association with a second timing tag, said second timing tag being related to a time at which said second information set is derived at said repeated executing step.

13. The method as in claim 1, wherein said product sales data describes sales of pharmaceuticals and wherein said product sales data includes the number of said products sold, and prices at which said products were sold, prices at which a manufacturer of said products has agreed under one or more contracts to sell products to predetermined customers.

14. The method as in claim 13, wherein said adjustments include adjustments to prices of one or more said product sales, rebates paid by said manufacturer, and charge backs paid by said manufacturer pursuant to said one or more contracts.

15. The method as in claim 14, wherein said algorithms determine an average manufacturing price, wherein said average manufacturing price describes net sales of said products over a predetermined time period divided by the number of said products sold in said period.

16. The method as in claim 15, wherein, in determining said average manufacturing price, said algorithms assess said net sales for products where said parties to which said products are sold are wholesalers that in turn sell said products to retail pharmacies.

17. The method as in claim 14, wherein said algorithms determine a best price of selected said products, wherein said best price describes the lowest price charged by said manufacturer for said selected products.

18. The method as in claim 17, wherein said best price excludes nominal prices of said selected products.

19. The method as in claim 14, wherein said algorithms determine a non-federal average manufacturing price, wherein said non-federal average manufacturing price describes net sales of said products over a predetermined time period divided by the number of said certain products sold in said period, and wherein said algorithms assess said net sales for products where said parties to which said products are sold are wholesalers that in turn sell said products to non-federal customers.

20. The method as in claim 1, including downloading outputting first information set in a predetermined report format.

21. In preparing predetermined information relating to product sales, as required by a regulatory entity not a party to the sales, from product sales data describing the sales maintained in one or more external computer and/or database systems, where the product sales data at least describes products sold, prices at which the products were sold, adjustments to sales of the products and parties to which the products were sold, and where the information is derived from the product sales data through one or more predetermined algorithms, a computerized method of acquiring and managing the product sales data, said method comprising the steps of:
receiving a plurality of sets of said product sales data from said one or more external systems, wherein each said product sales data set describes said sales occurring over a predetermined period of time and wherein said predetermined period of time is the same for each of said plurality of product sales data sets;
storing each said product sales data set in association with a timing tag, said timing tag being related to a time at which said product sales data set is received;
selecting one of said product sales data sets through its said associated timing tag;
executing said one or more algorithms upon said product sales data set selected at said selecting step; and
storing a first set of said information derived at said executing step.

22. The method as in claim 21, wherein each said timing tag includes a time at which its associated said product sales data set is received (“store time”) and an expiration time and wherein, for each said product sales data set having a next subsequently received product sales data set, said expiration time is equal to said store time of said next subsequently received product sales data set.

23. The method as in claim 22, wherein, upon said storing step for each said product sales data set and prior to said storing step for a subsequent said product sales data set, said expiration time defaults to a date substantially beyond said store time.

24. The method as in claim 22, wherein said selecting step includes selecting a desired time and selecting said product sales data set having an effective period, said effective period being defined by said store time and said expiration time of said product sales data, within which said desired time falls.

25. The method as in claim 21, wherein
said product sales data describes sales of pharmaceuticals,
said product sales data includes the number of said products sold, prices at which said products were sold, and prices at which a manufacturer of said products has agreed under one or more contracts to sell products to predetermined customers, and
said adjustments include adjustments to prices of one or more said product sales, rebates paid by said manufacturer, and charge backs paid by said manufacturer pursuant to said one or more contracts.

26. The method as in claim 25, wherein said algorithms determine
an average manufacturing price, wherein said average manufacturing price describes net sales of said products over a predetermined time period divided by the number of said products sold in said period,
a best price of selected said products, wherein said best price describes the lowest price charged by said manufacturer for said selected products, and
a non-federal average manufacturing price, wherein said non-federal average manufacturing price describes net sales of said products over a predetermined time period divided by the number of said certain products sold in said period, and wherein said algorithms in determining said non-federal average manufacturing price, assess said net sales for products where said parties to which said products are sold are wholesalers that in turn sell said products to non-federal customers.

27. The method as in claim 26, wherein, in determining said average manufacturing price, said algorithms assess net sales for products where said parties to which said products are sold are wholesalers that in turn sell said products to retail pharmacies.

28. In preparing predetermined information relating to sales of pharmaceuticals, as required by a regulatory entity not a party to the sales, from product sales data describing the sales maintained in one or more external computer and/or database systems, where the product sales data at least includes the number of products sold, prices at which the products were sold, parties to which the products were sold, prices at which a manufacturer of the products has agreed under one or more contracts to sell the products to predetermined customers, adjustments, if any, to the prices of the sales, charge backs paid by the manufacturer pursuant to the contracts and rebates paid by the manufacturer, a computerized method of acquiring the product sales data and determining the information therefrom, said method comprising the steps of:
receiving a set of said product sales data from said one or more external systems;
storing said product sales data set;
determining an average manufacturing price for selected said products, wherein said average manufacturing price describes net sales of said products over a first predetermined time period divided by the number of said products sold in said first period;
determining a best price of selected said products, wherein said best price describes the lowest price charged by said manufacturer for said selected products over a second predetermined time period;
determining a non-federal average manufacturing price for selected said products, wherein said non-federal average manufacturing price describes net sales of said products over a third predetermined time period divided by the number of said certain products sold in said third period, and wherein said net sales for non-federal average manufacturing price is assessed for products where said parties to which said products are sold are wholesalers that in turn sell said products to non-federal customers; and
storing and outputting said average manufacturing prices, said best prices and said non-federal average manufacturing prices.

29. The method as in claim 28, wherein said first period, said second period and said third period are the same and are a predetermined calendar quarter.

30. The method as in claim 29, wherein said outputting step includes outputting said average manufacturing prices and said best prices to a remote system that manages state Medicaid payments.

31. The method as in claim 28, wherein said parties are defined as predetermined trade classes describing types of pharmaceutical customers.

32. The method as in claim 31, wherein said trade classes are grouped as wholesale, retail or federal trade classes.

33. In preparing predetermined information relating to product sales, as required by a regulatory entity not a party to the sales, from product sales data describing the sales maintained in one or more external computer and/or database systems, where the product sales data at least describes products sold, prices at which the products were sold, adjustments to sales of the products and parties to which the products were sold, and where the information is derived from the product sales data through one or more predetermined algorithms, a computerized system for acquiring and managing the product sales data, said system comprising:
a computer program configured to receive a first set of said product sales data from said one or more external systems; and
a database;
wherein said computer program is configured to
store said first product sales data set in said database,
replace or modify said first product sales data set, while maintaining said first product sales data as it existed prior to said replacement or modification so that it is distinguishable from said replaced or modified product sales data set (“second product sales data set”),
receive a selection of one of said first product sales data set and said second product sales data set,
execute, responsively to receipt of said selection, said one or more algorithms upon said selected product sales data set, and
store a first set of said information derived from said selected product sales data set.

34. The system as in claim 33, wherein said computer program is configured to
receive a selection of the other of said first product sales data set and said second product sales data set,
execute, responsively to receipt of said selection, said one or more algorithms upon said other of said first product sales data set and said second product sales data set, and
store a second set of said information derived from said other of said first product sales data set and said second product sales data set, while maintaining said first information set.

35. The system as in claim 33, wherein said computer program is configured to store said first product sales data set in association with a first timing tag, said first timing tag being related to a time at which said first product sales data set is received.

36. The system as in claim 35, wherein
said timing tag includes a time at which said first product sales data set is received (“first store time”) and a first expiration time,
said computer program is configured to store said second product sales data set with a second timing tag, said second timing tag being related to a time at which said first product sales data set is replaced or modified,
said second timing tag includes a time at which said first product sales data set is replaced or modified (“second store time”) and a second expiration time, and
said computer program is configured to, upon replacing or modifying said first product sales data set, change said first expiration time to equal said second store time.

37. The system as in claim 36, wherein said computer program is configured to, upon receiving a desired time, select said product sales data set having an effective period, said effective period being defined by said store time and said expiration time of said product sales data, within which said desired time falls.

38. The system as in claim 33, wherein
said first product sales data describes said sales occurring over a predetermined period of time, and wherein said second product sales data set describes said sales occurring over the same said predetermined period as said first product sales data set,
said computer program is configured to store said first information set in association with a first timing tag, said first timing tag being related to a time at which said first information set is derived at said executing step,
said computer program is configured to receive a selection of the other of said first product sales data set and said second product sales data set,
said computer program is configured to, responsively to receipt of said selection, execute said one or more algorithms upon said other of said first product sales data set and said second product sales data set, and
said computer program is configured to store a second set of said information derived from said other of said first product sales data set and said second product sales data set in association with a second timing tag, said second timing tag being related to a time at which said second information set is derived.

39. In preparing predetermined information relating to product sales, as required by a regulatory entity not a party to the sales, from product sales data describing the sales maintained in one or more external computer and/or database systems, where the product sales data at least describes products sold, prices at which the products were sold, adjustments to sales of the products and parties to which the products were sold, and where the information is derived from the product sales data through one or more predetermined algorithms, a computerized system for acquiring and managing the product sales data, said system comprising:
a computer program configured to receive a plurality of sets of said product sales data from said one or more external systems, wherein each said product sales data set describes said sales occurring over a predetermined period of time and wherein said predetermined period of time is the same for each of said plurality of product sales data sets; and
a database,
wherein said computer program is configured to
store each said product sales data set in said database in association with a timing tag, said timing tag being related to a time at which said product sales data set is received,
receive a selection of one of said product sales data sets through its said associated timing tag,
execute, responsively to receipt of said selection, said one or more algorithms upon said product sales data set selected at said selecting step, and
store a first set of said information derived from said selected product sales data set.

40. The system as in claim 39, wherein each said timing tag includes a time at which its associated said product sales data set is received (“store time”) and an expiration time and wherein, for each said product sales data set having a next subsequently received product sales data set, said expiration time is equal to said store time of said next subsequently received product sales data set.

41. The system as in claim 40, wherein said computer program is configured to, upon receiving a desired time, select said product sales data set having an effective period, said effective period being defined by said store time and said expiration time of said product sales data, within which said desired time falls.

42. The system as in claim 39, wherein
said product sales data describes sales of pharmaceuticals,
said product sales data includes the number of said products sold, prices at which said products were sold and prices at which a manufacturer of said products has agreed under one or more contracts to sell products to predetermined customers, and
said adjustments include adjustments to prices of one or more said product sales, rebates paid by said manufacturer, and charge backs paid by said manufacturer pursuant to said one or more contracts.

43. The system as in claim 42, wherein said algorithms determine
an average manufacturing price, wherein said average manufacturing price describes net sales of said products over a predetermined time period divided by the number of said products sold in said period,
a best price of selected said products, wherein said best price describes the lowest price charged by said manufacturer for said selected products, and
a non-federal average manufacturing price, wherein said non-federal average manufacturing price describes net sales of said products over a predetermined time period divided by the number of said certain products sold in said period, and wherein said net sales for non-federal average manufacturing price is assessed for products where said parties to which said products are sold are wholesalers that in turn sell said products to non-federal customers.

44. The system as in claim 43, wherein said algorithms, in determining said average manufacturing price, assess net sales for products where said parties to which said products are sold are wholesalers that in turn sell said products to retail pharmacies.

45. In preparing predetermined information relating to sales of pharmaceuticals, as required by a regulatory entity not a party to the sales, from product sales data describing the sales maintained in one or more external computer and/or database systems, where the product sales data at least includes the number of products sold, prices at which the products were sold, parties to which the products were sold, prices at which a manufacturer of the products has agreed under one or more contracts to sell the products to predetermined customers, adjustments, if any, to the prices of the sales, charge backs paid by the manufacturer pursuant to the contracts and rebates paid by the manufacturer, a computerized system for acquiring the product sales data and determining the information therefrom, said system comprising:
a computer program configured to receive a set of said product sales data from said one or more external systems; and
a database,
wherein said computer program is configured to
store said product sales data set in said database,
determine an average manufacturing price for selected said products, wherein said average manufacturing price describes net sales of said products over a first predetermined time period divided by the number of said products sold in said first period,
determine a best price of selected said products, wherein said best price describes the lowest price charged by said manufacturer for said selected products over a second predetermined time period,
determine a non-federal average manufacturing price for selected said products, wherein said non-federal average manufacturing price describes net sales of said products over a third predetermined time period divided by the number of said certain products sold in said third period, and wherein said computer program assesses said net sales for non-federal average manufacturing price for products where said parties to which said products are sold are wholesalers that in turn sell said products to non-federal customers, and
store and output said average manufacturing prices, said best prices and said non-federal average manufacturing prices.
